(19) United States
(12) Patent Application Publication
(10) Pub. No.: US 2024/0388945 A1
(43) Pub. Date: Nov. 21, 2024

(54) RELIABILITY OF REPORTED PERFORMANCE INDICATORS

(71) Applicant: Telefonaktiebolaget LM Ericsson (publ), Stockholm (SE)

(72) Inventors: Athanasios KARAPANTELAKIS, Solna (SE); Maxim TESLENKO, Sollentuna (SE); Alexandros NIKOU, Danderyd (SE); Lackis ELEFTHERIADIS, Valbo (SE); Marin ORLIC, Bromma (SE)

(21) Appl. No.: 18/692,755

(22) PCT Filed: Sep. 17, 2021
(86) PCT No.: PCT/SE2021/050890

§ 371 Date: Mar. 15, 2024

(51) Int. Cl. H04W 24/10; H04W 8/18

(52) U.S. Cl. CPC H04W 24/10; H04W 8/18

(57) ABSTRACT

According to an aspect, there is provided a method of operating a control node, the method including receiving, from a third party node, a request for a value of a first performance indicator relating to one or more subscribers or to a first network slice; receiving, from a first communication network, a first value of the first performance indicator relating to the one or more subscribers in the first communication network or to the first network slice in the first communication network; determining a reliability of the received first value using a performance indicator profile; and performing an action with respect to the received request based on the determined reliability of the received first value.

### TECHNICAL FIELD OF THE INVENTION

This disclosure relates to an apparatus and method for determining a reliability of a value of a performance indicator reported to the apparatus by one or more communication networks.

### BACKGROUND OF THE INVENTION

For several future Internet of Things (IoT) applications that transcend geographical boundaries, connectivity services cannot be offered by a single Mobile Network Operator (MNO). Instead, there will be multiple network operators providing connectivity services across geographical boundaries (e.g. across country borders). A typical example of such application is autonomous vehicles that are communicating with cloud services. In this example, a vehicle may move between countries and coverage of a single operator. Roaming will allow the vehicle to maintain connectivity, as it is possible for the MNO offering the connectivity service to the vehicle owner (in this case vehicle owner can be the manufacturer or user of the vehicle). On the other hand, monitoring the quality of the connection is challenging as vehicles (also known as ‘mobile clients’ or User Equipment—UE), may roam across different network operators. Monitoring the quality of the connection may be particularly important, where, for example, there are quality of service (QoS) requirements on the connection.

Other examples of so-called “mission-critical” applications where connectivity may be provided across multiple network operators and where monitoring the quality of the connection may be desirable, include video cameras, tele-operated surgery equipment, remotely controlled drones, etc. Another example is where an entity that offers value added services on top of connected products, these entities would have their own QoS constraints for their application (for example vehicle fleet managers or hospital staff operating remote surgery equipment).

The Third Generation Partnership Project (3GPP) has introduced exposure services in the form of network nodes that securely expose capabilities of the mobile network to third parties, and enable these third parties to monitor the performance of their devices. For Long Term Evolution (LTE) networks, the node is known as a Service Capability Exposure Function (SCEF), whereas for 5^{th} Generation (5G) (New Radio (NR)), the node is known as a Network Exposure Function (NEF). These functions are designed to interact with applications on one side (the so-called “northbound” interface), to which they expose the network capabilities, and with network nodes on the other side (the so-called “southbound” interface), from which they obtain information. In 3GPP TR 23.708 v13.0.0 (2015-06), “3GPP Technical Specification Group Services and System Aspects; Architecture enhancements for service capability exposure” (Release 13), and 3GPP TS 23.222 v16.5.0 (2019-09), “3GPP Technical Specification Group Services and System Aspects; Functional architecture and information flows to support Common API Framework for 3GPP Northbound APIs; Stage 2” (Release 16), the concept of a “trust domain” is introduced for SCEF and NEF nodes respectively. The trust domain covers entities that are protected by adequate network domain security, and the entities and interfaces within the trust domain may all be within one operator's control, or some may be controlled by a trusted business partner which has a trust relationship with the operator e.g. another operator or a 3rd party. Trust domains can include other operators, meaning that operators can expose capabilities to third parties that involve other operators.

FIG. 1a corresponds to FIG. 6.1.1.2-1 of TR 22 23.708 v13.0.0 and shows a Service Capability Exposure architecture. FIG. 1b corresponds to FIG. 6.2.0-1 of TS 23.222 v16.5.0 and shows a functional model for the Common Application Program Interface (API) Framework (CAPIF) that includes a NEF, and in the case of 5G, 3GPP suggests the use of CAPIF for northbound API for Unified Data Management (UDM).

In both cases, when it comes to 3GPP NEF and SCEF nodes, it is possible for the trust domain to involve a “business partner”, the capabilities of which can be exposed to a third party via the exposure function. In this case the “third party” node is an Application Server (AS) or Application Function (AF) in 3GPP terms. An AS or AF can request information about a UE or group of UEs, by supplying their International Mobile Subscriber Identifier (IMSI), or about a network slice by providing a network slice identifier (NSI). The SCEF and NEF can collect information from different nodes of the core(s) and radio access network(s) and notify the AS/AF with new information when this information becomes available. In 5G mobile networks, the concept of network slicing allocates network resources (e.g. radio access, transport, compute) to specific types of communications services. Such types of communications services can fall into one of the three categories defined by the International Telecommunications Union (ITU): enhanced mobile broadband (eMBB), ultra-reliable low latency communications (uRLLC), and massive machine-type communications (mMTC).

However, in conventional approaches, MNOs need to engage manually in agreements with other MNOs in order to establish this trust domain. This is not only time consuming from a business perspective, but also from a technical perspective, as capability exposure systems of multiple MNOs need to be interconnected. Even if interconnectedness is achieved, the issue of accurate Key Performance Indicator (KPI) reporting from one or more MNOs still remains. That is, it is difficult for a MNO to determine KPIs for a subscriber, a group of subscribers or a network slice when the subscribers/slice are being served/provided by different communication networks. Examples of KPIs that can be of interest include network-level KPIs such as latency and/or throughput, network slice-related information such as load, and device-related information, such as number of reattachments and/or mobility patterns, etc.

Thus, it is difficult to detect the misreporting of a KPI or multiple KPIs for one or more subscribers, and/or a network slice by one or more communication networks, for example where a reported KPI value deviates from an actual value. It is noted that misreporting by a communication network may not be malicious (i.e. deliberate), and it could be that the misreporting is due to a fault in the network infrastructure or configuration (e.g. a software or firmware ‘bug’).

### SUMMARY OF THE INVENTION

Certain aspects of the present disclosure and their embodiments may provide solutions to the above or other challenges. In particular apparatus and methods are provided that store subscriber information for multiple communication networks to enable performance information to be more easily determined.

According to a first aspect, there is provided a method of operating a control node. The method comprises a method of operating a control node. The method comprises receiving, from a third party node, a request for a value of a first performance indicator relating to one or more subscribers or to a first network slice; receiving, from a first communication network, a first value of the first performance indicator relating to the one or more subscribers in the first communication network or to the first network slice in the first communication network; determining a reliability of the received first value using a performance indicator profile; and performing an action with respect to the received request based on the determined reliability of the received first value.

According to a second aspect, there is provided a computer program product comprising a computer readable medium having computer readable code embodied therein, the computer readable code being configured such that, on execution by a suitable computer or processor, the computer or processor is caused to perform the method according to the first aspect or any embodiment thereof.

According to a third aspect, there is provided a control node. The control node is configured to receive, from a third party node, a request for a value of a first performance indicator relating to one or more subscribers or to a first network slice; receive, from a first communication network, a first value of the first performance indicator relating to the one or more subscribers in the first communication network or to the first network slice in the first communication network; determine a reliability of the received first value using a performance indicator profile; and perform an action with respect to the received request based on the determined reliability of the received first value.

According to a fourth aspect, there is provided a control node. The control node comprises a processor and a memory, said memory containing instructions executable by said processor whereby said control node is operative to receive, from a third party node, a request for a value of a first performance indicator relating to one or more subscribers or to a first network slice; receive, from a first communication network, a first value of the first performance indicator relating to the one or more subscribers in the first communication network or to the first network slice in the first communication network; determine a reliability of the received first value using a performance indicator profile; and perform an action with respect to the received request based on the determined reliability of the received first value.

### BRIEF DESCRIPTION OF THE DRAWINGS

Various embodiments are described herein with reference to the following drawings, in which:

FIG. 1a shows a Service Capability Exposure architecture;

FIG. 1b shows a functional model for the CAPIF;

FIG. 2 is a block diagram illustrating various components of an exemplary system in which the techniques described herein can be implemented;

FIG. 3 is a block diagram of a control node according to various embodiments;

FIG. 4 is a block diagram of a network node according to various embodiments;

FIG. 5 is a block diagram of a third party node according to various embodiments;

FIG. 6 is a schematic block diagram illustrating a virtualisation environment in which functions implemented by some embodiments may be virtualised;

FIG. 7 is an illustration of an exemplary distributed ledger according to various embodiments;

FIG. 8 is a signalling diagram illustrating an exemplary process for subscription and asynchronous notification of KPIs;

FIG. 9 is a signalling diagram illustrating an exemplary process for updating exposure endpoints for subscribers;

FIG. 10 is a signalling diagram illustrating an exemplary process for unsubscribing from notifications of KPIs;

FIG. 11 is a signalling diagram illustrating an exemplary process of KPI report update functionality;

FIG. 12 is a flow chart illustrating an exemplary method of operating a control node according to a first set of embodiments;

FIG. 13 is a flow chart illustrating an exemplary method of operating a network node according to a first set of embodiments;

FIG. 14 is a flow chart illustrating an exemplary method of operating a third party node according to a first set of embodiments;

FIG. 15 is a flow chart illustrating an exemplary method of operating a control node according to a second set of embodiments;

FIG. 16 is an illustration of a reinforcement learning loop for a neural network applied to KPIs; and

FIG. 17 is a signalling diagram illustrating an exemplary process for determining the reliability of a reported KPI value.

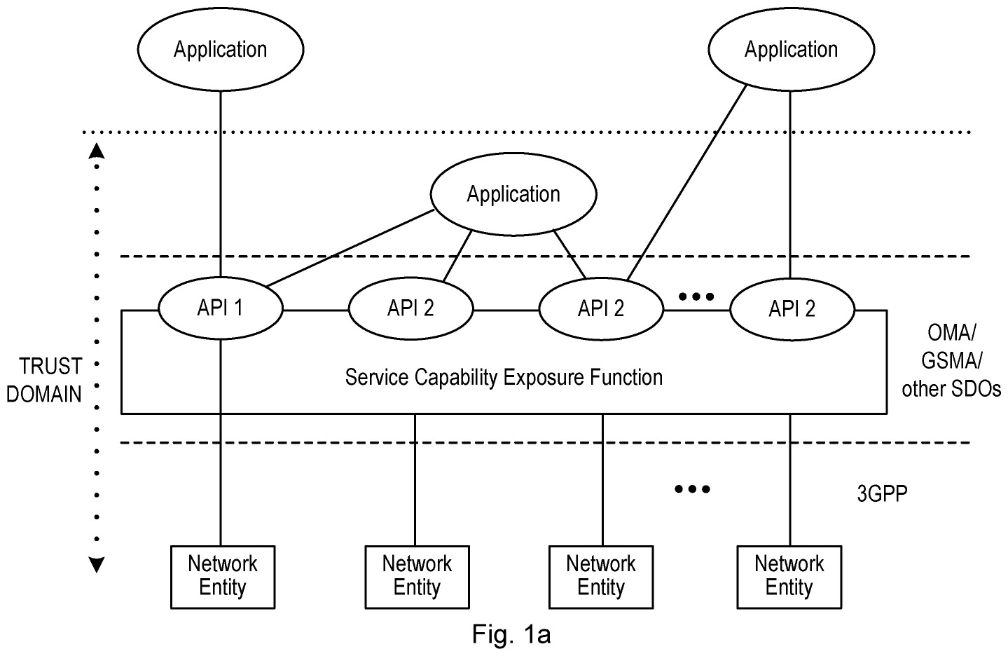

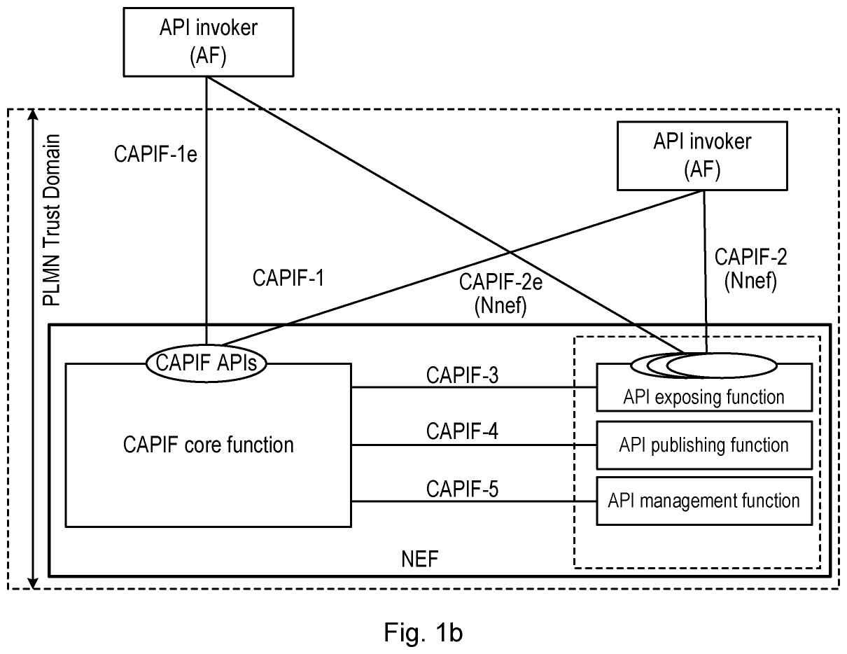

### DETAILED DESCRIPTION OF THE PREFERRED EMBODIMENTS

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Embodiments of this disclosure provide techniques for automating reporting of KPIs for a network slice provided by multiple MNOs; thus reducing the business and technical debt required for the task of cross-MNO KPI monitoring. Particular embodiments provide a distributed ledger for storing information on types of network slices provided by a first communication network operated by a first network operator or types of network slices provided by a second communication network operated by a second network operator. This distributed ledger can also include information on subscribers connected to the first communication network and the second communication network.

According to particular embodiments, a request can be received from a third party node for a performance indicator (KPI), with the request identifying one or more subscribers and/or one or more types of network slice that the first performance indicator is to relate to. A KPI value reported by a communication network for one or more subscribers and/or a network slice can be evaluated to detect whether the value is misreported using a performance indicator profile that represents or indicates ‘correct’ values for the KPI. Certain embodiments provide for the training of a machine learning model that learns about a “common profile” for one or more subscribers or a network slice. This profile can be computed against a KPI or group of KPIs for a subscriber, or group of subscribers or a network slice. Upon reporting of a KPI from, for example, an SCEF and/or NEF node, a control node can compare this KPI with the corresponding profile. If the KPI does not match the profile, then it can be marked as suspicious, and either not reported to the requesting entity, or reported with a warning as to the (potential) unreliability. In some embodiments, a number of suspicious KPIs from a specific source MNO can trigger an action, which can be one or all of the following: issuing a warning towards the MNO misreporting KPIs that KPIs are being misreported, warning the entities requesting the KPI that it may be unreliable, and filtering out the KPIs from the MNO reporting the KPI. For certain types of subscribers or requesting entities (e.g. a vehicle manufacturer), it is assumed that KPIs for a specific subscriber, group of subscribers or network slice will be reported from multiple operators. From a UE/subscriber perspective, this assumption is plausible due to UE mobility, i.e. UEs will roam from network to network. From a network slice perspective, the assumption is plausible because the same network slice can be instantiated using the same network slice template (NST) from different operators into a NSI.

Embodiments of this disclosure can provide one or more of the following advantages. For example, the simplified setup allows for quick bootstrapping of solutions, and can work with existing service exposure nodes, such as SCEF and NEF, without changes in the 3GPP standards, and does not need proprietary interfaces/implementation for cross-MNO communication. If KPIs are found to be misreported, MNOs can be warned about the misreporting, and/or enterprise entities requesting the KPIs can be warned that the KPIs are unreliable. In embodiments that use a distributed ledger, an advantage is that residual audit trails of KPI reporting is provided due to immutability of the distributed ledger, and can assist with identification of KPI misreporting. Another advantage is that this approach crowdsources the establishment of trust domains for multi-operator KPI reporting.

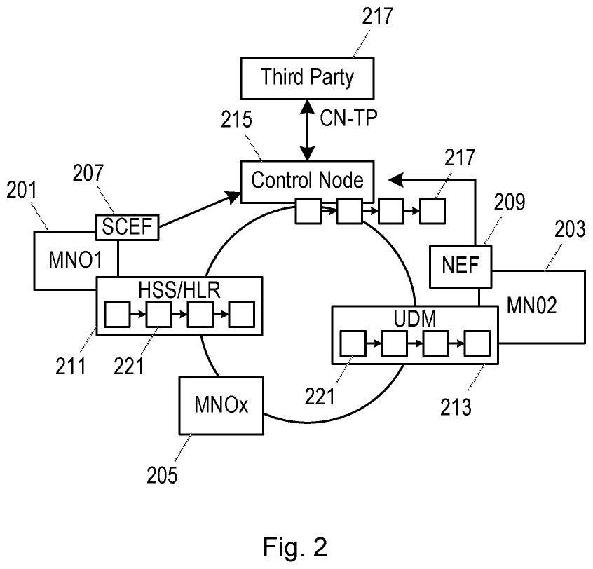

FIG. 2 is a block diagram illustrating various components of an exemplary system in which the techniques described herein can be implemented. Although FIG. 2 shows a system in which the techniques are applied to mobile communication networks defined according to the 3GPP standards such as 4G (LTE) and 5G (NR), it will be appreciated that the techniques described herein can be applied to other types of communication network, such as wired communication networks, e.g. based on IEEE 802.3x (Ethernet) or Fiber Distributed Data Interface (FDDI), or wireless communication networks, e.g. according to the IEEE 802.11 (WiFi) standards. FIG. 2 shows three mobile communication networks, a first mobile communication network 201 that is operated by a first mobile network operator (‘MNO1’), a second mobile communication network 203 that is operated by a second (different) mobile network operator (‘MNO2’), and a third mobile communication network 205 that is operated by another mobile network operator (‘MNOx’). As used herein, the terms ‘mobile communication network’ and ‘mobile network operator (MNO)’ are used interchangeably (i.e. a MNO operates a respective mobile communication network), but it will be appreciated that in some scenarios, a single MNO may operate multiple distinct mobile communication networks.

Each of the mobile communication networks 201, 203, 205 has an endpoint for securely exposing the capabilities of the respective network to third parties. These endpoints provide the northbound interface from the respective network, via which monitoring data can be provided. In this exemplary embodiment, the first mobile communication network 201 is a 4^{th} Generation (4G) network operating according to the LTE standards, and has an endpoint for exposing the capabilities of the first mobile communication network 201 in the form of a SCEF 207. Also in this exemplary embodiment, the second mobile communication network 203 is a 5G network operating according to the NR standards, and has an endpoint for exposing the capabilities of the second mobile communication network 203 in the form of a NEF 209. It will be appreciated that in alternative implementations, the first mobile communication network 201 and the second mobile communication network 203 can be any combination of 4G, 5G or subsequent generation networks (including being networks of the same type).

Each of the mobile communication networks 201, 203, 205 has one or more nodes 211, 213 for storing information relating to the subscribers to their network. In the case of the first mobile communication network 201, as the network is a 4G/LTE network, the node 211 is a Home Subscriber Server (HSS) or a Home Location Register (HLR). In the case of the second mobile communication network 203, as the network is a 5G/NR network, the node 213 is a UDM node.

A control node 215 is also provided that can operate according to some of the techniques described herein. The control node 215 is able to interface with each of the communication networks 201, 203, 205, via the respective endpoint, i.e. via the SCEF 207 in the case of the first mobile communication network 201 and via the NEF 209 in the case of the second mobile communication network 203. The control node 215 may be external to each of the mobile communication networks, as shown in FIG. 2, or, in alternative implementations, it can be part of one of the mobile communication networks. The control node 215 can also communicate with one or more third party nodes 217. In accordance with embodiments herein, the third party node 217 can request the control node 215 provide a performance indicator for a set of subscribers and/or for one or more types of network slice for the mobile communication networks 201, 203, 205, and the control node 215 can provide the performance indicator to the third party node 217. The control node 215 and third party node 217 may also undertake authorisation and/or authentication procedures.

In accordance with some embodiments of the techniques described herein, a distributed ledger 221 can be provided for storing information on the types of network slices supported by the first mobile communication network 201 and the second mobile communication network 203. Thus, the distributed ledger 221 can store information on the types of network slices supported by the first mobile communication network 201 and the types of network slices supported by the second mobile communication network 203. The types of network slices can include any of, but are not limited to, eMBB, uRLLC and mMTC. The distributed ledger 221 can also or alternatively store information on subscribers connected to any of the mobile communication networks. Thus, the distributed ledger 221 can store information on subscribers connected to the first mobile communication network 201 and subscribers connected to the second mobile communication network 203.

In FIG. 2, each of the control node 215, the HSS/HLR 211 and the UDM 213 store a respective copy of the distributed ledger 221. The respective copies of the distributed ledger 221 stored by the control node 215, the HSS/HLR 211 and the UDM 213 are identical (i.e. they comprise the same information), and the synchronisation between the content of the respective copies is maintained using distributed ledger protocols/architecture known to those skilled in the art. In some embodiments, and as illustrated in FIG. 2, the distributed ledger 221 is in the form of, or comprises, one or more blockchains. The use of distributed ledger 221 means that no individual MNO or mobile communication network is responsible for subscriber/network slice data, but instead it is delegated to the MNO/mobile communication network collective.

The distributed ledger 221 is a data structure that abides to the principle of replicability; i.e. it is shared and synchronised across multiple entities—in the present case the control node 215 and all mobile communication networks/MNOs have an exact copy of the data stored in the distributed ledger 221. In addition, distributed ledgers are immutable-meaning that data cannot be removed from the ledger. This allows for the creation of “audit trails”, meaning that it is possible to trace actions on the distributed ledger 221 back in time to the point of origin. A distributed ledger structure is therefore well suited for performance indicator reporting purposes, as it offers transparency, and potential accountability/liability, of action of every MNO to all other MNOs.

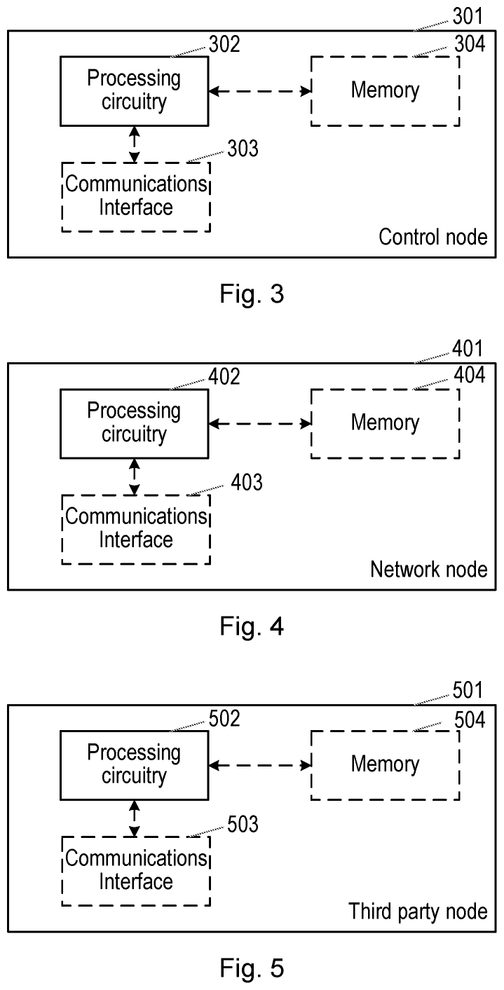

FIG. 3 is a block diagram of a control node 301 according to various embodiments that can be used to implement the techniques described herein. It will be appreciated that the control node 301 may comprise one or more virtual machines running different software and/or processes. The control node 301 may therefore comprise one or more servers, switches and/or storage devices and/or may comprise cloud computing infrastructure that runs the software and/or processes.

The processing circuitry 302 controls the operation of the control node 301 and can implement the methods described herein in relation to the control node. The processing circuitry 302 can comprise one or more processors, processing units, multi-core processors or modules that are configured or programmed to control the control node 301 in the manner described herein. In particular implementations, the processing circuitry 302 can comprise a plurality of software and/or hardware modules that are each configured to perform, or are for performing, individual or multiple steps of the method described herein in relation to the control node.

In some embodiments, the control node 301 may optionally comprise a communications interface 303. The communications interface 303 can be for use in communicating with other nodes, such as other virtual nodes. For example, the communications interface 303 can be configured to transmit to and/or receive from other nodes or network functions requests, resources, information, data, signals, or similar. The processing circuitry 302 may be configured to control the communications interface 303 of the control node 301 to transmit to and/or receive from other nodes or network functions requests, resources, information, data, signals, or similar.

Optionally, the control node 301 may comprise a memory 304. In some embodiments, the memory 304 can be configured to store program code that can be executed by the processing circuitry 302 to perform the method described herein in relation to the control node 301. Alternatively or in addition, the memory 304 can be configured to store any requests, resources, information, data, signals, or similar that are described herein. The processing circuitry 302 may be configured to control the memory 304 to store any requests, resources, information, data, signals, or similar that are described herein.

FIG. 4 is a block diagram of a network node 401 according to various embodiments that can be used to implement the techniques described herein. It will be appreciated that the network node 401 may comprise one or more virtual machines running different software and/or processes. The network node 401 may therefore comprise one or more servers, switches and/or storage devices and/or may comprise cloud computing infrastructure that runs the software and/or processes.

The processing circuitry 402 controls the operation of the network node 401 and can implement the methods described herein in relation to the network node. The processing circuitry 402 can comprise one or more processors, processing units, multi-core processors or modules that are configured or programmed to control the network node 401 in the manner described herein. In particular implementations, the processing circuitry 402 can comprise a plurality of software and/or hardware modules that are each configured to perform, or are for performing, individual or multiple steps of the method described herein in relation to the network node.

In some embodiments, the network node 401 may optionally comprise a communications interface 403. The communications interface 403 can be for use in communicating with other nodes, such as other virtual nodes. For example, the communications interface 403 can be configured to transmit to and/or receive from other nodes or network functions requests, resources, information, data, signals, or similar. The processing circuitry 402 may be configured to control the communications interface 403 of the network node 401 to transmit to and/or receive from other nodes or network functions requests, resources, information, data, signals, or similar.

Optionally, the network node 401 may comprise a memory 404. In some embodiments, the memory 404 can be configured to store program code that can be executed by the processing circuitry 402 to perform the method described herein in relation to the network node 401. Alternatively or in addition, the memory 404 can be configured to store any requests, resources, information, data, signals, or similar that are described herein. The processing circuitry 402 may be configured to control the memory 404 to store any requests, resources, information, data, signals, or similar that are described herein.

FIG. 5 is a block diagram of a third party node 501 according to various embodiments that can be used to implement the techniques described herein. It will be appreciated that the third party node 501 may comprise one or more virtual machines running different software and/or processes. The third party node 501 may therefore comprise one or more servers, switches and/or storage devices and/or may comprise cloud computing infrastructure that runs the software and/or processes.

The processing circuitry 502 controls the operation of the third party node 501 and can implement the methods described herein in relation to the network node. The processing circuitry 502 can comprise one or more processors, processing units, multi-core processors or modules that are configured or programmed to control the third party node 501 in the manner described herein. In particular implementations, the processing circuitry 502 can comprise a plurality of software and/or hardware modules that are each configured to perform, or are for performing, individual or multiple steps of the method described herein in relation to the third party node.

In some embodiments, the third party node 501 may optionally comprise a communications interface 503. The communications interface 503 can be for use in communicating with other nodes, such as other virtual nodes. For example, the communications interface 503 can be configured to transmit to and/or receive from other nodes or network functions requests, resources, information, data, signals, or similar. The processing circuitry 502 may be configured to control the communications interface 503 of the third party node 501 to transmit to and/or receive from other nodes or network functions requests, resources, information, data, signals, or similar.

Optionally, the third party node 501 may comprise a memory 504. In some embodiments, the memory 504 can be configured to store program code that can be executed by the processing circuitry 502 to perform the method described herein in relation to the third party node 501. Alternatively or in addition, the memory 504 can be configured to store any requests, resources, information, data, signals, or similar that are described herein. The processing circuitry 502 may be configured to control the memory 504 to store any requests, resources, information, data, signals, or similar that are described herein.

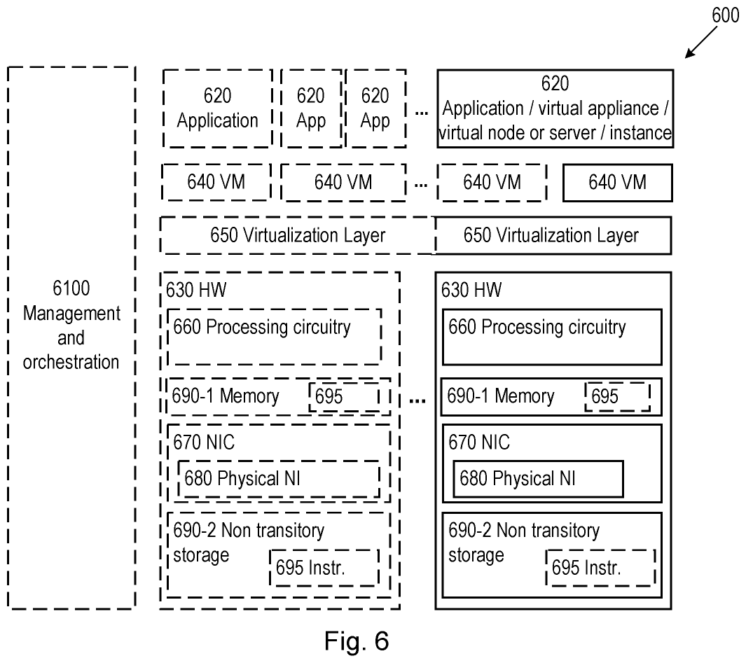

FIG. 6 is a schematic block diagram illustrating a virtualisation environment 600 in which functions implemented by some embodiments may be virtualised, such as functions of any of the control node 215/301, the network node 401 such as an HSS/HLR 211 or UDM 213, and/or the third party node 217/501. In the present context, virtualising means creating virtual versions of apparatuses or devices which may include virtualising hardware platforms, storage devices and networking resources. As used herein, virtualisation can be applied to a control node, a network node and a third party node, or components thereof, and relates to an implementation in which at least a portion of the functionality is implemented as one or more virtual components (e.g., via one or more applications, components, functions, virtual machines or containers executing on one or more physical processing nodes in one or more computer networks).

In some embodiments, some or all of the functions described herein may be implemented as virtual components executed by one or more virtual machines implemented in one or more virtual environments 600 hosted by one or more hardware nodes 630.

The functions of any of the control node 301, the network node 401 such as an HSS/HLR 211 or UDM 213, and/or the third party node 501 as described herein, may be implemented by one or more applications 620 (which may alternatively be called software instances, virtual appliances, network functions, virtual nodes, virtual network functions, etc.) operative to implement some of the features, functions, and/or benefits of some of the embodiments disclosed herein. Applications 620 are run in virtualisation environment 600 which provides hardware 630 comprising processing circuitry 660 and memory 690. Memory 690 contains instructions 695 executable by processing circuitry 660 whereby application 620 is operative to provide one or more of the features, benefits, and/or functions disclosed herein.

Virtualisation environment 600, comprises general-purpose or special-purpose network hardware devices 630 comprising a set of one or more processors or processing circuitry 660, which may be commercial off-the-shelf (COTS) processors, dedicated Application Specific Integrated Circuits (ASICs), or any other type of processing circuitry including digital or analog hardware components or special purpose processors. Each hardware device may comprise memory 690-1 which may be non-persistent memory for temporarily storing instructions 695 or software executed by processing circuitry 660.

Each hardware device may comprise one or more network interface controllers (NICs) 670, also known as network interface cards, which include physical network interface 680. Each hardware device may also include non-transitory, persistent, machine-readable storage media 690-2 having stored therein software 695 and/or instructions executable by processing circuitry 660. Software 695 may include any type of software including software for instantiating one or more virtualisation layers 650 (also referred to as hypervisors), software to execute virtual machines 640 as well as software allowing it to execute functions, features and/or benefits described in relation with some embodiments described herein.

Virtual machines 640, comprise virtual processing, virtual memory, virtual networking or interface and virtual storage, and may be run by a corresponding virtualisation layer 650 or hypervisor. Different embodiments of the instance of virtual appliance 620 may be implemented on one or more of virtual machines 640, and the implementations may be made in different ways.

During operation, processing circuitry 660 executes software 695 to instantiate the hypervisor or virtualisation layer 650, which may sometimes be referred to as a virtual machine monitor (VMM). Virtualisation layer 650 may present a virtual operating platform that appears like networking hardware to virtual machine 640.

As shown in FIG. 6, hardware 630 may be a standalone network node with generic or specific components. Hardware 630 may be part of a larger cluster of hardware (e.g. such as in a data centre or customer premise equipment (CPE)) where many hardware nodes work together and are managed via management and orchestration (MANO) 6100, which, among others, oversees lifecycle management of applications 620.

Virtualisation of the hardware is in some contexts referred to as network function virtualisation (NFV). NFV may be used to consolidate many network equipment types onto industry standard high volume server hardware, physical switches, and physical storage, which can be located in data centers, and customer premise equipment.

In the context of NFV, virtual machine 640 may be a software implementation of a physical machine that runs programs as if they were executing on a physical, non-virtualised machine. Each of virtual machines 640, and that part of hardware 630 that executes that virtual machine, be it hardware dedicated to that virtual machine and/or hardware shared by that virtual machine with others of the virtual machines 640, forms a separate virtual network elements (VNE).

Still in the context of NFV, Virtual Network Function (VNF) is responsible for handling specific network functions that run in one or more virtual machines 640 on top of hardware networking infrastructure 630 and corresponds to application 620 in FIG. 6.

Thus, in the context of the techniques described herein, and with reference again to FIG. 2, there are three main types of entities that can provide the described performance indicator reporting. A control node 215/301, a network node 211/213/401 such as a HSS/HLR node 211 or UDM 213, and a third party node 217/501.

The third party node 217 can be a subscriber to a network, for example an enterprise with many mobile subscriptions or a private individual, that may request the monitoring of one or more KPIs for their subscriber(s)/UEs. This can be done via a control node-third party (CN-TP) interface between the third party node 217 and the control node 215. This is a publish-subscribe type of interface, where the third party node 217 subscribes to one or more events, such as monitoring events defined by 3GPP standards, and receives an asynchronous notification when these events happen. In the context of the techniques described herein, these events are KPIs, or information relating to KPIs.

The request for subscribing to one or more events (KPIs) contains identifiers for one or more subscriptions that the event relates to. In some embodiments, the identifiers are International Mobile Subscriber Identifiers (IMSIs), or International Mobile Equipment Identifiers (IMEIs), but other types of identifiers can be used, in particular in different types of communication network. For example, a device or subscriber can be identified using a Media Access Control (MAC) address of a network interface controller (NIC) used by the device or subscriber to access the network. In the following, reference is made to IMSIs, but unless otherwise indicated, it will be appreciated that other types of device or subscriber identifier can be used. These identifiers are used by for control node 215 to determine which wireless device(s)/mobile device(s)/UE(s) that they need to offer monitoring information on. The KPI may be a single event, or a combination of events, provided by a “monitoring” functionality of the relevant endpoint 207, 209 (exposure function). For example the monitoring functionality can relate to any of loss of connectivity, reachability, location, communication failure, roaming status, etc. In some embodiments, information about which event(s) to receive notifications for can also be included in the request. The response may be asynchronous (i.e. the response occurs some time later when information is available, and not just as a reaction to receiving the request) and contains information about the event(s) that have been triggered.

The control node 215 acts as a mediator between the third party node 217 and the exposure functions 207, 209 of the mobile communication networks 201, 203. One optional function of the control node 215 is to authenticate the third party node 217 to enable access to information provided by the exposure functions 207, 209. Another function of the control node 215 is to subscribe to events on behalf of the third party node 217 and notify the third party node 217 when data is available for the event that the third party node 217 requested. In this way, the third party node 217 (or the subscriber/owner of the third party node 217) does not need to interface with mobile communication networks 201, 203 or MNOs directly, nor does it need to be aware to which MNO its subscribers/UEs are connected or attached to.

The control node 215 is a logical entity, which means that it can be a single point of contact (SPOC) and either reside within one of the mobile communication networks 201, 203 of one of the MNOs, or be cloud service that is hosted in an external data centre. In some embodiments, the distributed ledger 221 stores access information, such as the Uniform Resource Identifier (URI)-based address, port, etc., for the endpoint/exposure function 207, 209 of each MNO/mobile communication network, as well as subscriber information. The single point of contact arrangement is shown in FIG. 2, and this configuration is more likely to be the case for local deployments, and can involve both MNOs and Mobile Virtual Network Operators (MVNOs).

In an alternative approach, the control node 215 can be distributed across multiple MNOs 201, 203, meaning that every MNO 201, 203 has their own copy of the control node 215. In this configuration the request/response workload and throughput are distributed across multiple MNOs 201, 203. This approach is more likely for global deployments.

Finally, the MNOs 201, 203 participate in the techniques described herein via their endpoint node (exposure function node) 207, 209, and mobile subscriber database (HSS/HLR 211 in LTE and UDM 213 in 5G). Typically, these databases are restricted to the domain of the MNO 201, 203 that owns them. A difference is that in the present disclosure, part of the information typically stored in a subscriber database can also be stored in distributed ledger 221, meaning that subscriber information is accessible by every MNO that has access to the distributed ledger 221. Information on network slices provided by each MNO can also be stored in the distributed ledger 221.

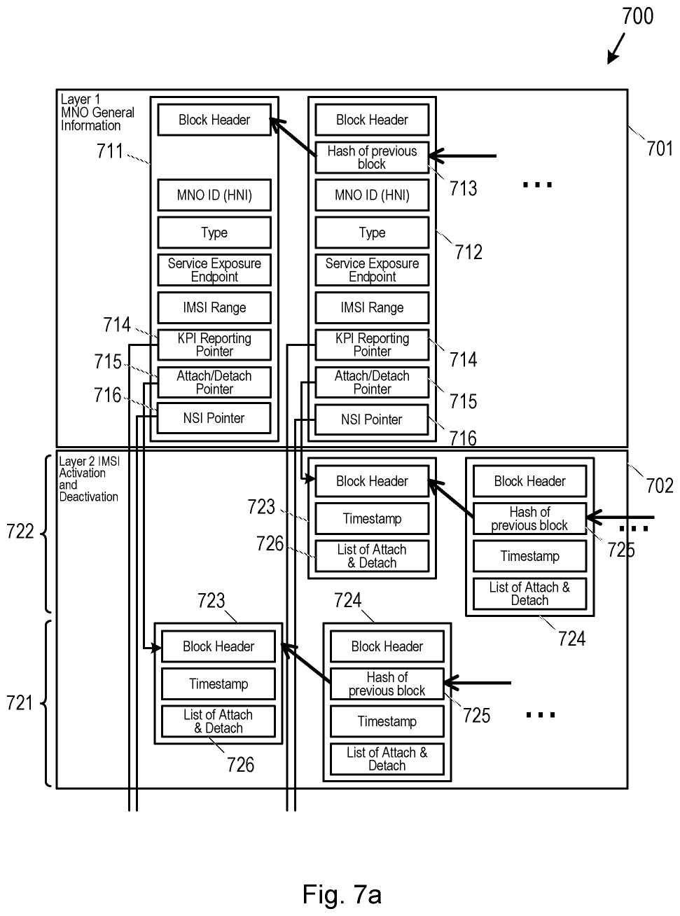

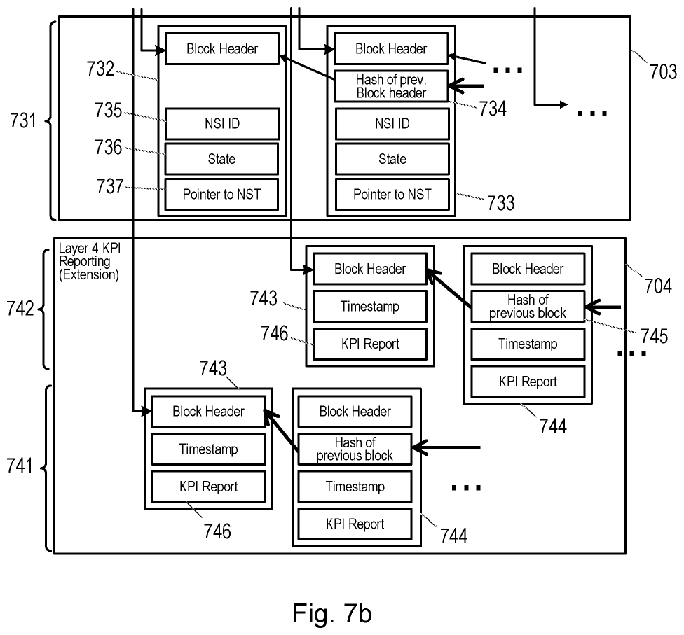

An exemplary distributed ledger 700 comprising several blockchains (or sub-blockchains) according to various embodiments is shown in FIG. 7. FIG. 7 is split into two parts, FIGS. 7a and 7b. Specific implementations of the distributed ledger 700 may include any or all of the illustrated layers, and/or any of the illustrated blockchains/sub-blockchains. Likewise, specific implementations of the distributed ledger 700 may include any or all of the types of information shown within each block of the blockchains/sub-blockchains.

Thus, the distributed ledger 700 shown in FIG. 7 comprises four layers, a first layer 701 that stores information about the MNOs/mobile communication networks that are participating in the distributed ledger 700, a second layer 702 that stores information about the subscribers connected to each of the mobile communication networks 201, 203, 205, a third layer 703 that stores information about network slices in each of the mobile communication networks 201, 203, 205, and a fourth layer 704 that can store information relating to the reporting of performance indicators. FIG. 7a shows the first layer 701 and the second layer 702, and FIG. 7b shows the third layer 703 and the fourth layer 704. Each layer includes or comprises one or more blockchains. The second and fourth layers 702 and 704, in particular, are optional, and in certain embodiments one or both are not present. The first layer 701 is also referred to herein as the “MNO General Information layer” or the “MNO information layer” or “Layer 1”. The second layer 702 is also referred to herein as the “IMSI Activation and Deactivation layer” or the “subscriber information layer” or “Layer 2”. The third layer 703 is also referred to herein as the “NSI Creation/Operation/Teardown” layer or “Layer 3”. The fourth layer 704 is also referred to herein as the “KPI Reporting layer” or “Layer 4”.

The first layer 701 (MNO General Information layer) can contain general information about the network operators. In some embodiments, the first layer 701 is a blockchain and the information for each network operator/communication network can be stored in a respective block of the Layer 1 blockchain 701. The Layer 1 blockchain 701 is also referred to herein as a “network information blockchain”. The information for each network operator/communication network can be provided by the respective network operator/communication network. In the example of FIG. 7, a first block 711 stores first network information, which is information for a first MNO/first mobile communication network, and a second block 712 stores second network information, which is the information for a second MNO/second mobile communication network. Information for further MNOs/mobile communication networks will be stored in respective further blocks of the Layer 1 blockchain 701. Each block includes one or more data fields for storing particular information about the respective MNO/mobile communication network. The second block 712, and subsequent blocks, each contain a data field 713 that is a hash of the previous block in the Layer 1 blockchain 701 (thereby creating the blockchain).

Each block 711, 712 in the first layer 701 comprises information about the respective network operator/communication network. This information can comprise any of: a network identifier, for example a unique Home Network Identifier (HNI) for a 3GPP network, another unique network identifier for non-3GPP networks, including identifiers such as company registration numbers, etc.; information for an endpoint of the network, for example the service exposure endpoint (which can be a combination of an IP address, a port, and protocol to interface with SCEF/NEF node of the respective MNO); and a range of subscriber identities the operator/network is responsible for, such as an IMSI Range which is a range of IMSIs. There may also be a “type” data field, which denotes the type of the entry for the respective operator: if it is the first entry of the operator in the blockchain 701 then the type is set to “new”, if it is a subsequent update (of any or a combination of service exposure endpoint and IMSI range(s) then the type can be set to “update”. Each block 711, 712 can also include a header field that is used to store information that can identify the block.

In the exemplary embodiment shown in FIG. 7, each block 711, 712 in the first layer 701 can also comprise one or more data fields 714, 715, 716 that provide a ‘pointer’ to the relevant information for the respective network stored in the second layer 702 (IMSI Activation and Deactivation layer), the creation, operation and/or teardown information for a network slice in the third layer 703 (NSI Creation/Operation/Teardown layer) and/or the fourth layer 704 (KPI Reporting). That is the information in data fields 714, 715, 716 can indicate which block or blockchain in the second layer 702, the third layer 703 or the fourth layer 704 includes the information for the respective mobile communication network. Data field 714 provides a pointer to the relevant KPI reporting information for the respective mobile communication network in the third layer 703, data field 715 provides a pointer to the relevant information for a network slice, and data field 716 provides a pointer to the relevant subscriber information for the respective mobile communication network in the second layer 702.

The second layer 702 (IMSI Attach/Detach layer) stores information about the subscribers connected to each of the mobile communication networks 201, 203, 205. As noted, the second layer 702, and the information stored therein, is optional. In particular, the second layer 702 stores information about any subscribers connected (or attached) to a particular mobile communication network, and may also store information about subscribers that have disconnected (or detached) from the particular mobile communication network. It will be appreciated that due to the possibility of roaming between networks, the subscribers attached to a particular mobile communication network may include subscribers of other network operators. In other words, the subscribers connected to a particular mobile communication network may include subscribers with identities not in the IMSI range of that mobile communication network. The subscriber information for each network operator/communication network can be provided by the respective network operator/communication network.

In this exemplary embodiment the second layer 702 comprises a respective Layer 2 blockchain or sub-blockchain for each of the MNOs that has a respective block in the first layer 701. Thus, the second layer 702 comprises a first Layer 2 blockchain 721 that includes the information for subscribers connected to the first mobile communication network 201, and a second Layer 2 blockchain 722 that includes the information for subscribers connected to the second mobile communication network 203. The subscriber information contained in each block of the Layer 2 blockchains 721, 722 can be in the form of a list of subscriber identifiers that are connected to and/or disconnected from the respective network.

The first Layer 2 blockchain 721 comprises at least a first block 723. In embodiments where the first block 711 in the first layer 701 includes a pointer in data field 715, the pointer can indicate or ‘point to’ the first block 723 in the first Layer 2 blockchain 721. The first block 723 in the first Layer 2 blockchain 721 can include a first list of subscriber identifiers for subscribers connected to the first mobile communication network 201. If the subscriber information for the first mobile communication network 201 is to be updated, a further block is added to the first Layer 2 blockchain 721 containing the updated information. This updated information can be in the form of an updated list of connected and/or disconnected subscribers for the first mobile communication network 201. Thus, in the illustrated example there is also a second block 724 in the first Layer 2 blockchain 721. The second block 724, and subsequent blocks, each contain a data field 725 that is a hash of the previous block in the first Layer 2 blockchain 721 (thereby creating the blockchain). Each block includes a data field 726 with a list (or updated list) of subscribers that are connected (attached) to the first mobile communication network 201. Each block may include a list (or updated list) of subscribers that are disconnected (detached) from the first mobile communication network 201. This list may be stored in the same or a different data field 726 to the list of connected subscribers. In some embodiments, the list of connected subscribers stored in each block 723, 724 can include all subscribers that are connected to the first mobile communication network 201. This embodiment can improve the speed with which a status of a particular subscriber can be determined in subsequent steps of the techniques described herein as only the latest block of the blockchain needs to be queried. However, this can result in each block being quite large in terms of data size. Therefore in alternative embodiments, to reduce the size of the list stored in each block 723, 724, each block 723, 724 may only store information on subscribers that have connected to the first mobile communication network 201 since the previous block and/or disconnected from the first mobile communication network 201 since the previous block.

Each block 723, 724 can include a header field that is used to store information that can identify the block. Each block 723, 724 can include a timestamp field that is used to store a timestamp for that particular block. The timestamp is typically the time (e.g. date and time) that the respective block was added to the first Layer 2 blockchain 721.

As noted, the second Layer 2 blockchain 722 includes the information for subscribers connected to (and disconnected from) the second mobile communication network 203. The second Layer 2 blockchain 722 has a similar structure to the first Layer 2 blockchain 721, and thus includes a first block 723, a second block 724, etc. The first block 723 in the second Layer 2 blockchain 722 can include a second list of subscriber identifiers for subscribers connected to the second mobile communication network 203. Thus the various embodiments described above for the blocks in the first Layer 2 blockchain 721 can also apply to the second Layer 2 blockchain 722. In embodiments where the second block 712 in the first layer 701 includes a pointer in data field 715, the pointer can indicate or ‘point to’ the first block 723 in the second Layer 2 blockchain 722.

The third layer 703 (NSI creation, operation and teardown) stores information relating to network slices in the mobile communication networks 201, 203, 205. The information stored in the third layer 703 can also be referred to herein as ‘NSI information’ or ‘network slice information’.

In this exemplary embodiment the third layer 703 comprises a respective Layer 3 blockchain or sub-blockchain for each of the MNOs that has a respective block in the first layer 701. Each Layer 3 blockchain can be referred to as a “network slice information blockchain”. Thus, the third layer 703 comprises a first Layer 3 blockchain 731 that includes the network slice information for the first mobile communication network 201. Although not shown in FIG. 7b, there can be a second Layer 3 blockchain that includes the network slice information for the second mobile communication network 203.

The first Layer 3 blockchain 731 comprises at least a first block 732. In embodiments where the first block 711 in the first layer 701 includes a pointer in data field 716, the pointer can indicate or ‘point to’ the first block 732 in the first Layer 3 blockchain 731. Any time that the network slice information for the first mobile communication network 201 is to be updated, a further block is added to the first Layer 3 blockchain 731 containing the updated network slice information. Thus, in the illustrated example there is also a second block 732 in the first Layer 3 blockchain 731. The second block 733, and subsequent blocks, each contain a data field 734 that is a hash of the previous block in the first Layer 3 blockchain 731 (thereby creating the blockchain). Each block can include several data fields 735, 736, 737 with the relevant network slice information for the first mobile communication network 201. Data field 735 can be a NSI ID field 735 that stores an NSI identifier, e.g. data that identifies the type of network slice(s) that the block 732 relates to. Data field 736 can be a State field 736 that stores state information for the NSI ID in field 735. The state information can be any of, for example, suspended, rebooting, operational, under creation, under teardown, expired, etc. Data field 737 can be a ‘Pointer to NST’ field 737 that stores information about the network slice template (NST) that the network slice was instantiated from.

Each block 732, 733 can include a header field that is used to store information that can identify the block. Although not shown in FIG. 7b, each block 732, 733 can include a timestamp field that is used to store a timestamp for that particular block. The timestamp is typically the time (e.g. date and time) that the respective block was added to the first Layer 3 blockchain 731.

As noted, a second Layer 3 blockchain can include the performance information for the second mobile communication network 203. The second Layer 3 blockchain will have a similar structure to the first Layer 3 blockchain 731. Thus the various embodiments described above for the blocks in the first Layer 3 blockchain 731 can also apply to a second Layer 3 blockchain. In embodiments where the second block 712 in the first layer 701 includes a pointer in data field 716, the pointer can indicate or ‘point to’ a first block in the second Layer 3 blockchain.

The fourth layer 704 (KPI Reporting layer) stores information relating to the reporting of performance indicators about the subscribers connected to each of the mobile communication networks 201, 203, 205. As noted, the fourth layer 704, and the information stored therein, is optional. The information stored in the fourth layer 704 can help to establish a trust domain across the MNOs participating in the distributed ledger 700, and thus the information stored in the fourth layer 704 can also be referred to herein as ‘trust information’. In some embodiments, the performance information can relate to a reliability of a value of a performance indicator provided by the first communication network 201 and/or the second communication network 203. In some embodiments, the performance information stored in the fourth layer 704 can be received from the third party node 217.

In this exemplary embodiment the fourth layer 704 comprises a respective Layer 4 blockchain or sub-blockchain for each of the MNOs that has a respective block in the first layer 701. Each Layer 4 blockchain can be referred to as a “trust information blockchain”. Thus, the fourth layer 704 comprises a first Layer 4 blockchain 741 that includes the performance indicator information for subscribers connected to the first mobile communication network 201, and a second Layer 4 blockchain 742 that includes the performance indicator information for subscribers connected to the second mobile communication network 203.

The first Layer 4 blockchain 741 comprises at least a first block 743. In embodiments where the first block 711 in the first layer 701 includes a pointer in data field 714, the pointer can indicate or ‘point to’ the first block 743 in the first Layer 4 blockchain 741. Any time that the performance information for the first mobile communication network 201 is to be updated, a further block is added to the first Layer 4 blockchain 741 containing the updated performance information. Thus, in the illustrated example there is also a second block 744 in the first Layer 4 blockchain 741. The second block 744, and subsequent blocks, each contain a data field 745 that is a hash of the previous block in the first Layer 4 blockchain 741 (thereby creating the blockchain). Each block includes a data field 746 with performance information (e.g. a KPI report) for the first mobile communication network 201.

Each block 743, 744 can include a header field that is used to store information that can identify the block. Each block 743, 744 can include a timestamp field that is used to store a timestamp for that particular block. The timestamp is typically the time (e.g. date and time) that the respective block was added to the first Layer 4 blockchain 741.

As noted, the second Layer 4 blockchain 742 includes the performance information for the second mobile communication network 203. The second Layer 4 blockchain 742 has a similar structure to the first Layer 4 blockchain 741, and thus includes a first block 743, a second block 744, etc. Thus the various embodiments described above for the blocks in the first Layer 4 blockchain 741 can also apply to the second Layer 4 blockchain 742. In embodiments where the second block 712 in the first layer 701 includes a pointer in data field 714, the pointer can indicate or ‘point to’ the first block 743 in the second Layer 4 blockchain 742.

As noted above, the data structure of the distributed ledger 700 shown in FIG. 7 is merely exemplary, and it will be appreciated by those skilled in the art that the described information can be stored in a number of different ways in distributed ledger 700. Determining the data structure to use in particular implementation may be a trade-off between the data size of individual blocks and the speed with which required information can be retrieved from the distributed ledger 700. For example, to minimise the data size of individual blocks, each block may only include information that has changed since the previous block or an earlier block. As noted above, this can be applied to the subscriber information and/or the network slice information, and each block may only include information for subscribers for which their connection status has changed or information for network slices for which the relevant information has changed. However, the trade-off with minimising the data size of blocks is that it may be necessary to examine multiple blocks in a blockchain to find the relevant information. On the other hand, if each block includes all available information, including information that has not been updated from a previous block, block sizes may become quite large, but it may only be required to examine the most recent block in the blockchain to find the relevant information.

In some alternative embodiments, one or more layers of the multi-layer structure shown in FIG. 7 can be omitted, or the information contained in the different layers combined into a single layer. In some alternative embodiments, each layer may comprise a single blockchain with each block including the information (updated or complete, depending on the implementation) relating to all of the MNOs/mobile communication networks. In some alternative embodiments, the distributed ledger 700 does not use blockchains to store the information, and an alternative data structure can be used. For example the distributed ledger can be in the form of one or more distributed hash tables (DHTs).

In some embodiments, the control node 215 (and in some embodiments only the control node 215) is responsible for adding new blocks to the various blockchains in the distributed ledger 700. As noted, the mobile communication networks 201, 203 each store a local copy of the distributed ledger 700, and the distributed ledger architecture ensures that the local copies of the distributed ledger 700 in the first mobile communication network 201 and the second mobile communication network 203 are kept aligned or synchronised as new blocks are added by the control node 215. For example the control node 215 can receive updated subscriber information from the first mobile communication network 201, and add a new block to the first Layer 2 blockchain 721 that includes the updated subscriber information. The local copies of the distributed ledger 700 will then be updated to include a copy of the new block.

In further alternative embodiments for the data structure, the Layer 1 information, the Layer 2 information, the Layer 3 information and/or the Layer 4 information can be stored in separate distributed ledgers. For example, the Layer 2 information can be stored in a first distributed ledger, the Layer 1 information can be stored in the first distributed ledger or a second distributed ledger, the Layer 3 information can be stored in the first distributed ledger, in the second distributed ledger or in a third distributed ledger, and the Layer 4 information can be stored in the first distributed ledger, in the second distributed ledger, in the third distributed ledger or in a fourth distributed ledger.

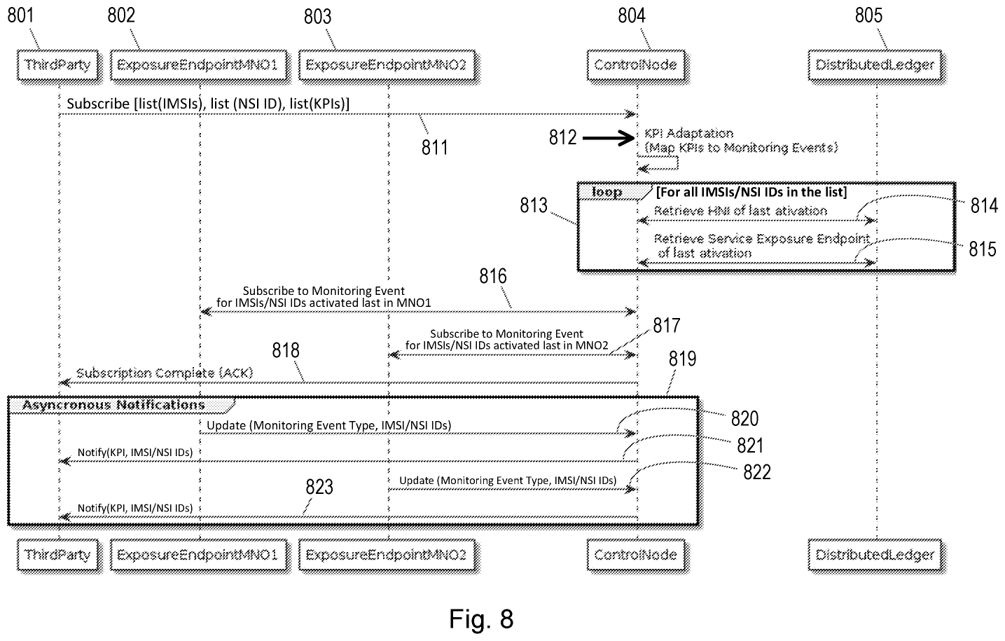

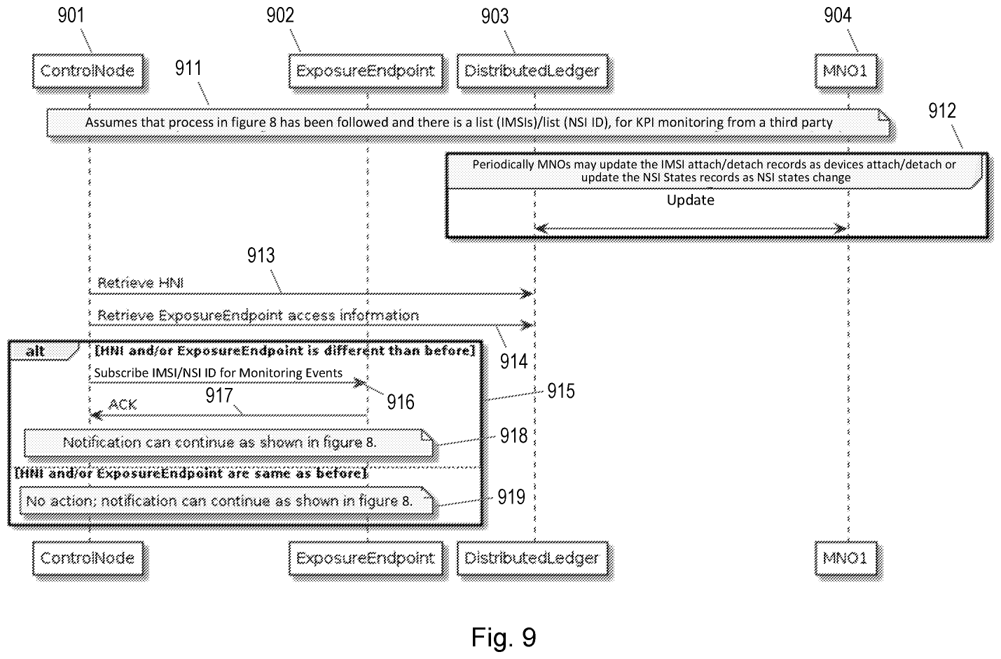

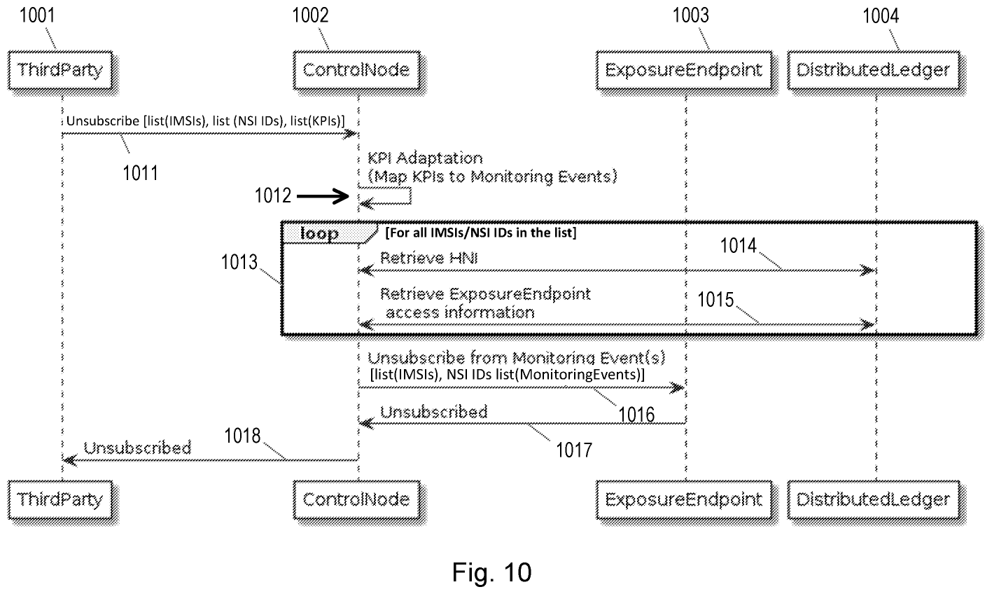

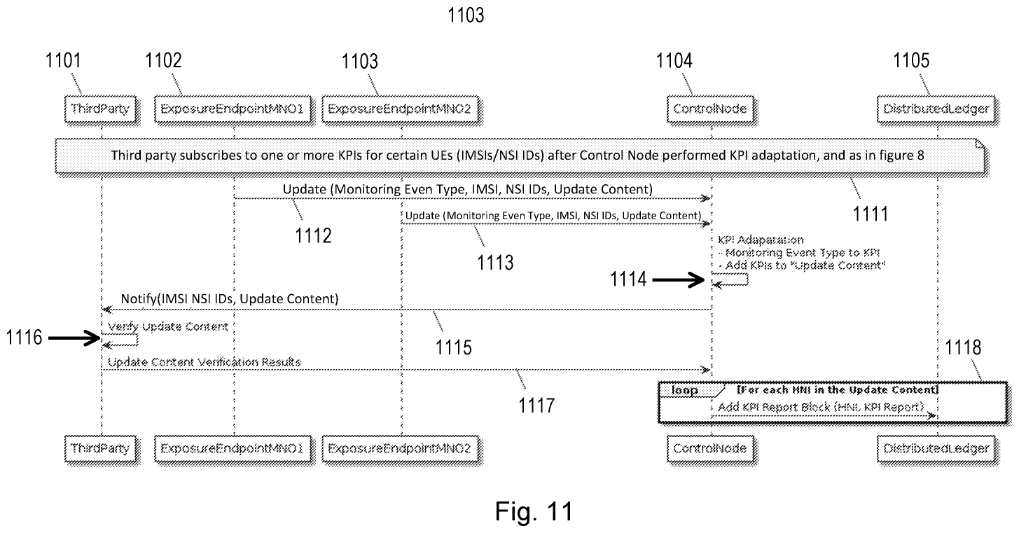

The signalling diagrams in FIGS. 8-11 illustrate various exemplary interactions between the MNOs/communication networks, the control node and the distributed ledger.

In particular, FIG. 8 is a signalling diagram illustrating an exemplary process for subscription and asynchronous notification of KPIs. FIG. 8 shows the signalling between third party node 801, an endpoint 802 (e.g. a SCEF or NEF) for the first mobile communication network (referred to as ‘first endpoint 802’), an endpoint 803 (e.g. a SCEF or NEF) for the second mobile communication network (referred to as ‘second endpoint 803’), the control node 804 and the distributed ledger 805.

In step 811 the third party node 801 sends a subscription request to the control node 804. The subscription request can include a list of subscribers (e.g. a list of IMSIs) that the subscription request relates to and/or a list of network slices (e.g. a list of NSI IDs) that the subscription request relates to. The subscription request may also comprise an indication of a performance indicator (e.g. one or more KPIs) that the third party node 801 would like to receive for those subscribers and/or network slices.

If necessary, in step 812 the control node 804 maps the requested performance indicator (KPI) to one or more monitoring events relevant to the first mobile communication network and the second mobile communication network.

In the case of the subscription request relating to one or more subscribers, in process 813, the control node 804 queries the distributed ledger 805 to identify the mobile communication network that each of the listed subscribers is connected to. In more detail, for all subscriber identities (IMSIs) in the subscription request, the control node 804 queries (step 814) the distributed ledger 805 to determine (and subsequently receive) the identity (e.g. HNI) of the mobile communication network that the subscriber was last active/connected to. In addition, for all subscriber identities (IMSIs) in the subscription request, the control node 804 queries (step 815) the distributed ledger 805 to determine (and subsequently receive) the identity and/or information for the endpoint of the mobile communication network that the subscriber was last active/connected to. The information for the endpoint can comprise any of an IP address, a port, and protocol to interface with SCEF/NEF node.

Thus, with reference to the exemplary distributed ledger structure in FIG. 7, in steps 814 and 815, the control node 804 queries the blockchain(s) 721, 722 in the second layer 702 to determine which mobile communication network the subscriber is connected to or was last connected to, and then retrieves the information about the mobile communication network (step 814) and endpoint information (step 815) from the relevant block 711, 712 in the first layer 701 (e.g. from the MNO ID data field and the Service Exposure Endpoint data field.

In the case of the subscription request relating to one or more network slices, the control node 804 queries the distributed ledger 805 to identify the mobile communication network(s) that provide each of the listed network slices. In more detail, for all network slice identities (NSI IDs) in the subscription request, the control node 804 queries (step 814) the distributed ledger 805 to determine (and subsequently receive) the identity (e.g. HNI) of the mobile communication network(s) that provide the network slice. In addition, for all network slice identities (NSI IDs) in the subscription request, the control node 804 queries (step 815) the distributed ledger 805 to determine (and subsequently receive) the identity and/or information for the endpoint of the mobile communication network(s) providing the network slice(s). The information for the endpoint can comprise any of an IP address, a port, and protocol to interface with SCEF/NEF node.

Thus, with reference to the exemplary distributed ledger structure in FIG. 7, in steps 814 and 815, the control node 804 queries the blockchain 731 in the third layer 703 to determine which mobile communication networks are providing the identified network slice(s), and then retrieves the information about the mobile communication network (step 814) and endpoint information (step 815) from the relevant block 711, 712 in the first layer 701 (e.g. from the MNO ID data field and the Service Exposure Endpoint data field.

In steps 816 and 817 the control node 804 then subscribes to the monitoring events determined in step 812 in the relevant mobile communication network(s) for the subscribers/network slices identified in the subscription request (step 811). That is, for the subscribers identified in the request that are determined in step 813 to be connected to the first mobile communication network, the control node 804 subscribes to monitoring events for those subscribers in that network via the first endpoint 802 (step 816). For the subscribers identified in the request that are determined in process 813 to be connected to the second mobile communication network, the control node 804 subscribes to monitoring events for those subscribers in that network via the second endpoint 803 (step 817). For the network slices identified in the request that are determined in step 813 to be provided by the first mobile communication network, the control node 804 subscribes to monitoring events for that network slice in that network via the first endpoint 802 (step 816). For the network slices identified in the request that are determined in process 813 to be provided by the second mobile communication network, the control node 804 subscribes to monitoring events for that network slice in that network via the second endpoint 803 (step 817).

In step 818 the control node 804 then sends an acknowledgement to the third party node 801 indicating that it has set up the required subscriptions indicated in the request in step 811.

In process 819, the control node 804 receives updates from the mobile communication networks when the requested monitoring event information is available. Thus, in step 820, the control node 804 may receive an update from the first mobile communication network via the first endpoint 802, with the update including an indication of the monitoring event type and the subscriber(s) (IMSI(s))/network slice(s) (NSI IDs) that the monitoring event relates to. In step 821, if step 812 was performed, the control node 804 may map the received monitoring event to the requested KPI(s), and send the KPI(s), along with the relevant subscriber/network slice identities, to the third party node 801 in step 821. The signal in step 821 can be sent using the CN-TP interface. If step 812 was not required, the control node 804 can just send the received monitoring event information, along with the relevant subscriber/network slice identities, to the third party node 801 in step 821. Steps 822 and 823 correspond to steps 820 and 821 respectively for the second mobile communication network.

Thus, the method shown in FIG. 8 enables a third party node 801 to subscribe to updates for a particular set of subscribers/network slices, and for the control node 804 to obtain that information and provide it to the third party node 801.

FIG. 9 is a signalling diagram illustrating an exemplary process for updating exposure endpoints for subscribers and/or network slices. FIG. 9 shows the signalling between control node 901, an endpoint 902 (e.g. a SCEF or NEF) for a second mobile communication network (referred to as ‘first endpoint 902’), the distributed ledger 903 and the first mobile communication network 904.

Process 911 assumes that the method shown in FIG. 8 has been performed and that there is a list of subscriber identities (IMSIs) or network slices (NSI IDs) for which performance indicators have been requested.

In step 912, there is an update to the subscribers connected to the first mobile communication network 904 or an update to the network slice(s) provided by the first mobile communication network 904, and this information is added to the distributed ledger 903. It should be noted that although FIG. 9 shows signalling between the first mobile communication network 904 and the distributed ledger 903, this information will be added to the distributed ledger 903 by the control node 901. Step 912 may occur any time that there is a change to a connection status of a subscriber in the first mobile communication network 904 or a change to a state of a network slice in the first mobile communication network 904, but alternatively an update can occur periodically and/or once a sufficient number of changes have occurred.

In step 913, which can be performed periodically for each subscriber/network slice or all subscribers/network slices, the control node 901 checks the network identity (e.g. HNI) for any subscribers/network slices identified in a third party node's KPI subscription request by querying the distributed ledger 903. Likewise, in step 914 the control node 901 checks the endpoint information for any subscribers/network slices identified in the third party node's KPI subscription request by querying the distributed ledger 903. Steps 913 and 914 are performed in a similar way to steps 814 and 815 of FIG. 8.

In the event that steps 913 and 914 indicate that the connection status of a subscriber or state of a network slice for which a monitoring event was established in steps 816 or 817 of FIG. 8 has changed (e.g. the subscriber is connected to a different mobile communication network, or the state of the network slice has changed), process 915 is performed to update the monitoring event subscriptions.

In process 915 if the information for a first subscriber has been updated to indicate that the first endpoint 902 is the new relevant endpoint for the first subscriber, then in step 916 the control node 901 sends a subscription request to the first endpoint 902 to subscribe to monitoring events for the first subscriber. In step 917 the first endpoint 902 acknowledges the request. Steps 916 and 917 are similar to steps 816, 817 and 818 in FIG. 8. In step 918 the control node 901 can receive notifications/updates from the first endpoint 902 and send notifications/updates to the third party node as described above with reference to steps 820 and 821 (step 919).

Also in process 915, if the information for a first subscriber has not been updated, then the control node 901 can continue to receive notifications/updates from the relevant endpoint and send notifications/updates to the third party node as described above with reference to steps 820 and 821.

FIG. 10 is a signalling diagram illustrating an exemplary process for unsubscribing from notifications of KPIs. In particular, FIG. 10 shows a process that enables the third party node to unsubscribe from previously-requested performance indicators for specific subscribers and/or network slices.

FIG. 10 shows the signalling between third party node 1001, control node 1002, an endpoint 1003 (e.g. a SCEF or NEF) for a first mobile communication network (referred to as ‘first endpoint 1003’), and the distributed ledger 1004.

In step 1011 the third party node 1001 sends an unsubscribe request to the control node 1002. The unsubscribe request can include a list of subscribers (e.g. a list of IMSIs) or network slice(s) (NSI IDs) that the unsubscribe request relates to, and/or an indication of a performance indicator (e.g. one or more KPIs) that the third party node 1001 no longer wishes to receive for those subscribers/network slices.

If necessary, in step 1012 the control node 1002 maps the performance indicator (KPI(s) to one or more monitoring events relevant to the first mobile communication network and the second mobile communication network.

In process 1013, the control node 1002 queries the distributed ledger 1004 to identify the mobile communication network that each of the listed subscribers is connected to or that provide the listed network slice(s). In more detail, for all subscriber identities (IMSIs)/network slice(s) identities (NSI IDs) in the subscription request, the control node 1002 queries (step 1014) the distributed ledger 1004 to determine (and subsequently receive) the identity (e.g. HNI) of the mobile communication network that the subscriber was last active/connected to or that provides the relevant network slice(s). In addition, for all subscriber identities (IMSIs)/network slice(s) (NSI IDs) in the subscription request, the control node 1002 queries (step 1015) the distributed ledger 1005 to determine (and subsequently receive) the identity and/or information for the endpoint of the mobile communication network that the subscriber was last active/connected to or that provides the relevant network slices. The information for the endpoint can comprise any of an IP address, a port, and protocol to interface with SCEF/NEF node. It will be appreciated that process 1013 and steps 1014 and 1015 are similar to process 813 and steps 814 and 815 described above.

In steps 1016 and 1017 the control node 1002 then unsubscribes from the monitoring events determined in step 1012 in the relevant mobile communication network for the subscribers/network slices identified in the unsubscribe request (step 1011). That is, for the subscribers/network slices identified in the request that are determined in step 1013 to be connected to the first mobile communication network, the control node 1002 unsubscribes from monitoring events for those subscribers/network slices in that network via the first endpoint 1003 (step 1016). In step 1017, the first endpoint 1003 sends an acknowledgement to the control node 1002 confirming that the unsubscribe request has been implemented.

In step 1018 the control node 1002 then sends an acknowledgement to the third party node 1001 indicating that it has unsubscribed for the relevant subscribers/network slices indicated in the unsubscribe request received in step 1011.

The following part of the description provides more detailed examples of KPIs and how they can be reported. From the perspective of the customer (e.g. the third party node), a KPI can be defined in high-level or domain specific terms, for example “network retainability” (nᵣₑₜ) or “network accessibility” (n_{acc}). These high level KPIs can be quantitative or qualitative and take into account one or more network level KPIs—i.e. metrics that can be measured directly by the MNO, using network probes such as counters. For example, assuming that nᵣₑₜ is qualitative and n_{acc} is quantitative, the formulas below show how they could relate to network level KPIs:

$${n}_{ret} = \{ \begin{matrix}poor if & \frac{{\sum }_{UEID = N}^{UEID = 1} \frac{{ERABAbnormalRelease}_{UEID}}{{ERABRelease}_{UEID}}}{N} > 0.8 \\ mediocre if & 0.2 \leq \frac{{\sum }_{UEID = N}^{UEID = 1} \frac{{ERABAbnormalRelease}_{UEID}}{{ERABRelease}_{UEID}}}{N} \leq 0.8 \\ good if & \frac{{\sum }_{UEID = N}^{UEID = 1} \frac{{ERABAbnormalRelease}_{UEID}}{{ERABRelease}_{UEID}}}{N} \leq 0.2\end{matrix}$$

$${n}_{acc} = \frac{\begin{matrix}\frac{{\sum }_{UEID = N}^{UEID = 1} \frac{{RRCConnectionSuccess}_{UEID}}{{RRCConnectionAttempt}_{UEID}}}{N} + \\ \frac{{\sum }_{UEID = N}^{UEID = 1} \frac{{ERABSetupSuccess}_{UEID}}{{ERABSetupAttempt}_{UEID}}}{N}\end{matrix}}{3}$$

These exemplary KPIs are discussed by F. Krasniqi, A. Maraj and E. Blaka in “Performance analysis of mobile 4G/LTE networks”, South-Eastern European Design Automation, Computer Engineering, Computer Networks and Society Media Conference (SEEDA_CECNSM), Kastoria, 2018, pp. 1-5. The network accessibility (n_{acc}) shows how accessible is the connectivity service to the customer. It is based on the Radio Resource Control (RRC) protocol call setup success rate (CSSR), which evaluates how many connections where established as a fraction of the total number of connection attempts. Additionally, E-UTRAN Radio Access Bearer (ERAB) setup success measures how many data bearers were allocated correctly as a ratio of the total number of attempts. The average score for all UEs belonging to the customer/third-party is taken into account. The network-level KPIs “RRCConnectionSuccess”, “RRCConnectionAttempt”, “ERABSetupSuccess” and “ERABSetupAttempt” are used to determine the network accessibility (n_{acc}). In the above formula, the ratio “RRCConnectionSuccess” to “RRCConnectionAttempt” provides the RRC Call Setup Success Rate (RRC CSSR), which represents the call success rate in a cell or cluster, while the ratio “ERABSetupSuccess” to “ERABSetupAttempt” provides the ERAB Setup Success rate, which represents the setup success rate for all services in the cell or group of cells.

Similarly, the network retainability (nᵣₑₜ) measures the capability of the network to ensure services are up and running without interruption. This can use the network-level KPIs “ERABnormalRelease” and “ERABRelease”. In the above formula, the ratio “ERABnormalRelease” to “ERABRelease” provides a Call Drop Rate (CDR) which represents the capability of the system to provide services without interruption.

As noted above with reference to the process illustrated in FIG. 9, it is possible for an MNO (via the control node) to update their connected/disconnected blockchain (e.g. the blockchains 721 and 722 in the second layer 702 of the distributed ledger 700 shown in FIG. 7) as wireless devices (with IMSIs), connect/attach and disconnect/detach from the network. Likewise, it is possible for an MNO (via the control node) to update their NSI Creation/Operation/Teardown blockchain (e.g. the blockchain 731 in the third layer 703 of the distributed ledger 700 shown in FIG. 7) as the state of the network slice(s) change. In these cases, another principle of distributed ledger techniques—that of “consensus”—can be applied before a new update is issued (i.e. before a new block is added). This means that every MNO and the control node need to verify the new update from an MNO before it is added to the relevant blockchain. This guarantees the security of the approach by preventing, e.g., “rogue” initiatives from MNOs declaring subscribers connected or disconnected to their network, while these subscribers are, for example, connected to another network. For this particular example, a first MNO to declare an IMSI attach event, all other MNOs need to agree that the particular IMSI is not already attached to one of their respective networks. As noted above, the fourth layer 704 in the distributed ledger 700 can be used to form a trust domain among the MNOs. Automatic formation of trust domains allows for reporting of KPIs to third parties only for reliable MNOs. Additionally, it not only accelerates the time-to-market of connectivity services, as it negates the need for MNOs to manually negotiate between themselves, but also opens up opportunities for new collaborations and therefore new revenue channels. The distributed ledger is important for this mechanism to work and the signalling diagram in FIG. 11 illustrates exemplary processes for KPI report update functionality.

FIG. 11 shows the signalling between third party node 1101, an endpoint 1102 (e.g. a SCEF or NEF) for the first mobile communication network (referred to as ‘first endpoint 1102’), an endpoint 1103 (e.g. a SCEF or NEF) for the second mobile communication network (referred to as ‘second endpoint 1103’), the control node 1104 and the distributed ledger 1105.

At step 1111, it is assumed that the third party node 1101 has subscribed to reports of one or more KPIs in respect of one or more subscribers/network slices as shown in FIG. 8.

In step 1112, the control node 1104 receives an update from the first mobile communication network via the first endpoint 1102 relating to a previously-requested monitoring event. Thus, in step 1112, the control node 1104 may receive an update including an indication of the monitoring event type, the subscriber(s) (IMSI(s))/network slice(s) (NSI IDs) that the monitoring event relates to, and updated content for the monitoring event. In step 1113, the control node 1104 receives an update from the second mobile communication network via the second endpoint 1103 relating to a previously-requested monitoring event. Thus, in step 1113, the control node 1104 may receive an update including an indication of the monitoring event type, the subscriber(s) (IMSI(s)/network slice(s) (NSI IDs) that the monitoring event relates to, and updated content for the monitoring event.

If necessary, in step 1114, the control node 1104 may map the received monitoring event/updated content to the previously-requested KPI(s), and send the KPI(s) and updated content, along with the relevant subscriber identities/network slice identities (NSI IDs), to the third party node 1101 in step 1115.

In step 1116, the updated content is verified by the third party node 1101. In one embodiment, the third party node 1101 can do their own test on the updated content, for example, by detecting which of their subscribers/wireless devices lost connectivity from an application-level protocol, and comparing that to the reported KPIs. In another embodiment, customers (the third party node 1101) can also perform a correlation of KPIs within a KPI update and between KPIs reported from different MNOs. If, for example, it is observed that a number of MNOs in a certain area report KPIs within a certain range of values, while another MNO reports outlier KPIs (e.g. out of that range), while the service experience from a customer perspective is uniform among all MNOs, then this may indicate misreporting on behalf of the aforementioned MNO.

Once the updated content is verified in step 1116, verification results can be sent to the control node 1104 (step 1117). For example, step 1117 can comprise sending a trust index to the control node 1105, which adds it to the distributed ledger 1105 as “KPI report” (step 1118). This KPI report can be added to the blockchain(s) in the third layer 703 of the distributed ledger 1105. It should be noted that in order for the KPI report to be added, there has to be a consensus from all other entities involved with the distributed ledger 1105, in addition to the MNO which has misreported the KPI. In this way, the distributed ledger 1105 can function as a warning to the relevant MNO that there may be issues regarding their KPI reporting infrastructure, especially if repeated notifications are not verified from the third party node 1101. In an alternative embodiment, it is also possible, if repeated notifications are unverified, that the control node 1104 ceases reporting KPIs originating from one MNO, or for certain IMSIs/network slices, for a duration of time.

Finally, there may also be the issue of a third party node 1101 producing an incorrect verification of the KPI data provided by the MNO. For example a “malicious” third party node 1101 may always report that updated content from an MNO has been misreported, resulting in a very low trust index for that MNO. Therefore, the control node 1104 may also verify whether the trust index has been calculated correctly by the third party node 1101 prior to adding it to the distributed ledger 1105. This verification can comprise comparing the trust index with trust indices for the same MNO from other third party nodes, on the same reporting timeframe. If the verification is found to be incorrect, then a notification can be sent to the third party node 1101 by the control node 1104 that it will not be added into the distributed ledger 1105.

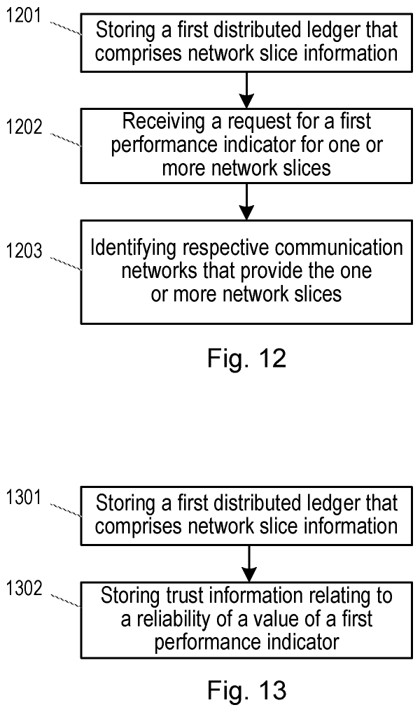

Embodiments of the techniques presented herein will now be described in more detail with reference to the flow charts in FIGS. 12, 13 and 14, which are flow charts illustrating exemplary methods of operating a control node, a network node (e.g. an HSS/HLR or UDM) and a third party node respectively according to certain embodiments. These methods can be performed by control node, the network node and the third party node shown in FIGS. 3, 4 and 5 respectively.

Thus, FIG. 12 shows an exemplary method of operating a control node according to a first set of embodiments. Step 1201 comprises the control node 215 storing a first distributed ledger 221. The first distributed ledger 221 comprises network slice information. The network slice information is information on network slices provided by a first communication network 201 that is operated by a first network operator and information on network slices provided by a second communication network 203 that is operated by a second network operator. One or both of the first communication network 201 and the second communication network 203 may be a wireless communication network.

In step 1202, a request for a first performance indicator is received from a third party node 217. The received request identifies one or more network slices that the first performance indicator is to relate to. The first performance indicator may be a KPI.

In step 1203, the network slice information stored in the first distributed ledger 221 is used to identify the respective communication networks that provide the one or more identified network slices.

In some embodiments, the method further comprises the control node 215 requesting performance information relating to the first performance indicator for the one or more identified network slices in the respective identified communication networks. This step may comprise subscribing to an event relating to the first performance indicator for the one or more identified network slices in the respective identified communication networks.

In some embodiments, the control node 215 may query the first distributed ledger 221 over time to obtain further network slice information relating to the one or more network slices that the first performance indicator is to relate to. For any network slice for which the network slice information has changed, the control node 215 can update the subscription to the event.

In some embodiments, the control node 215 may determine the performance information to be requested based on the first performance indicator. In particular, in this step the control node 215 may map the first performance indicator/KPI to an event or monitoring event provided by the respective communication network.

In some embodiments, the method can further comprise receiving the requested performance information from the respective identified communication networks. The control node 215 may then determine the first performance indicator from the received performance information. The method can further comprise the control node 215 sending the determined first performance indicator to the third party node 217.

In some embodiments, step 1203 comprises receiving an address for an endpoint of the communication network that is providing the identified network slice. This address may be a URI-based address, port, for the endpoint/exposure function 207, 209 for the relevant communication networks 201, 203.

In some embodiments, the method can further comprise receiving updated network slice information from one or both of the first network operator/first communication network 201 and the second network operator/second communication network 203 relating to network slices provided by the respective one of the first communication network 201 and the second communication network 203. The control node 215 can store this updated network slice information in the first distributed ledger 221.

In some embodiments, the first distributed ledger 221 comprises a first list of network slice identifiers for network slices provided by the first communication network 201 and a second list of network slice identifiers for network slices provided by the second communication network 203. In these embodiments, a timestamp may be associated with the first list. The timestamp may indicate the time at which the list was added to the first distributed ledger 221. In some embodiments, the first list is stored in the first distributed ledger 221 as a respective block 732 of a first blockchain 731 for the first communication network 201, and the second list is stored in the first distributed ledger 221 as a respective block 221 of a second blockchain for the second communication network 203.

In embodiments where updated network slice information is received, the updated network slice information can be in the form of an updated first list and/or an updated second list. The updated first list is stored in the first distributed ledger 221 as a further block 733 of the first blockchain 731, and the second updated list is stored in the first distributed ledger 221 as a further block of the second blockchain.

In some embodiments, the method further comprises storing first network information comprising information on the first communication network 201 and/or on the first network operator, and storing second network information comprising information on the second communication network 203 and/or on the second network operator. The first network information and the second network information may be stored in the first distributed ledger 221 or in a second distributed ledger. The first network information may be stored in the first distributed ledger 221 or in the second distributed ledger as a block 711 of a network information blockchain 701, and the second network information may be stored in the first distributed ledger 221 or in the second distributed ledger as a further block 712 of the network information blockchain 701.

In some embodiments, the method further comprises receiving trust information from the third party node 217. The trust information relates to a reliability of a value of the first performance indicator for one or both of the first communication network 201 and the second communication network 203. The control node 215 can store the received trust information in the first distributed ledger 221, in the second distributed ledger (if present), or in a third distributed ledger. The trust information may be stored as a block in a trust information blockchain 731 in the first distributed ledger 221 or in the second or third distributed ledger.

In some embodiments, the first communication network 201 has one of a NEF and a SCEF, and the second communication network has one of a NEF and a SCEF, and the network slice information for the network slices provided by the first communication network 201 is obtained via the one of the NEF and the SCEF of the first communication network 201, and the network slice information for the network slices provided by the second communication network 203 is obtained via the one of the NEF and the SCEF of the second communication network 203.

FIG. 13 shows an exemplary method of operating a network node according to a first set of embodiments. The network node is a node in the first communication network 201, which is operated by the first network operator. The network node is responsible for storing the distributed ledger 221. In some embodiments, the network node is an HSS/HLR 211, or a UDM 213.

In step 1301, the network node 211, 213 stores a first distributed ledger 221 that comprises network slice information. The network slice information can be as described above with respect to step 1201. Moreover, the first distributed ledger 221 may include further information/blocks as described above with reference to FIG. 12.

In step 1303, the network node 211, 213 also store, in the first distributed ledger 221, or in a second distributed ledger, trust information relating to a reliability of a value of a first performance indicator for one or both of the first communication network 201 and the second communication network 203. The trust information may be stored as a block in a trust information blockchain 731 in the first distributed ledger 221 or in a second distributed ledger. In some embodiments, this trust information may have originated from a third party node 217.

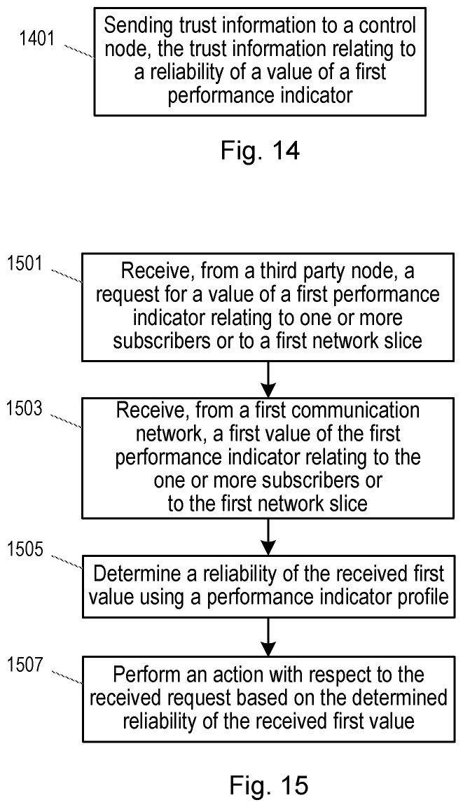

FIG. 14 shows an exemplary method of operating a third party node 217 according to general embodiments. The third party node 1101 may be an Application Server (AS) or an Application Function (AF). In step 1401, the third party node 217 sends trust information to a control node 215. The trust information relates to a reliability of a value of a first performance indicator for one or both of a first communication network 201 operated by a first network operator and a second communication network 203 operated by a second network operator.

In some embodiments, the method can further comprise sending to the control node 215 a request for the first performance indicator. The first performance indicator may be a KPI. The request can identify one or more network slices that the first performance indicator is to relate to. The method may then further comprise receiving the requested first performance indicator from the control node 215.

It will be appreciated that any of the above first set of embodiments can be applied to subscriber information in addition to or alternatively to network slice information.

As noted above, certain embodiments of this disclosure relate to techniques for determining the reliability of a reported performance indicator value with reference to a performance indicator profile. These techniques can be implemented in the system shown in FIG. 2, although it will be appreciated that in these ‘performance indicator reliability embodiments’ the use of a distributed ledger to store information such as subscriber information, network slice information and/or reported performance indicator values is optional, and alternative data structures can be used to store this information in a distributed or non-distributed way.

The control node 215, which acts as a ‘middleman’ between third party node 217 (which could be external to the network operator, e.g. an enterprise customer), accepts performance indicator (hereafter referred to as KPI) reporting requests from the third party node 217 relating to one or more subscribers, and/or one or more network slices, and contacts the SCEF/NEF nodes of MNO that serve the UEs with IMSIs included in the reporting request or that provide the network slices with NSI IDs included in the reporting request. The control node 215 can then receive the requested KPIs. If necessary, the control node 215 can perform a KPI translation, in case the received KPI includes an ‘abstract’ KPI that needs to be translated to network (recognised) KPIs. Such translation can also or alternatively include scaling a received KPI value to a different measurement scale or measurement unit. In order to find to which mobile communication network/MNO UEs are attached to, or which mobile communication network/MNO provides a network slice of interest, the control node 215 can consult a database, such as the distributed ledger described above, which is updated by the mobile communication networks/MNOs themselves. The database can be regularly updated by the MNOs with lists of attached UEs and/or the provided network slices and their state. The use of a distributed ledger for this database has advantages due to its properties of replicability, immutability and consensus, which make it useful for multi-vendor and/or multi-MNO environments.

Once the requested KPI value(s) are received, the control node 215 can use a performance indicator profile to determine if the received KPI value(s) are reliable. Based on that determination, which could be represented by a confidence indicator that indicates the reliability of the reported KPI value, the control node 215 could communicate the KPI value(s) back to the third party node 217, along with the confidence indicator. Alternatively the control node 215 could filter out reported KPI value(s) if the confidence indicator is lower, or consistently lower, than a threshold. In some embodiments, the control node 215 could notify the MNO or mobile communication network that reported the KPI value(s) that the reported KPI value(s) were unreliable.

The flow chart in FIG. 15 illustrates an exemplary method of operating a control node 215 according to the ‘performance indicator reliability embodiments’. This method can be performed by the control node shown in FIG. 3.

Step 1501 comprises the control node 215 receiving a request for a value of a first performance indicator (e.g. a first KPI) relating to one or more subscribers or to a first network slice. This request is received from a third party node 217. In the case of subscribers, the received request can comprise identifiers for the one or more subscribers, for example in the form of IMSIs, or any other type of equipment or subscriber identifier. In the case of network slices, the received request can comprise identifiers for one or more network slices, for example in the form of NSI IDs, or any other type of network slice identifier.

In some embodiments of step 1501, the control node 215 can identify which communication network(s) the one or more subscribers are currently connected to or which communication network(s) provide the first network slice. The control node 215 can subscribe to the identified communication network(s) in order to receive values of the first performance indicator when available. In some embodiments, the control node 215 can identify the communication network(s) by querying a database that stores suitable information, such as the distributed ledger shown in FIG. 7. Thus, in the case of the request relating to one or more subscribers, the control node 215 can identify the MNOs that these subscribers are connected to by querying the most recent blocks 723, 724 in the blockchains 721, 722 for the different MNOs. In the case of the request relating to one or more network slices, the control node 215 can identify the MNOs that provide these network slices by querying the most recent blocks 732, 733 in the blockchain 731 for the different MNOs. In this case the control node 215 may also determine the NST that the relevant network slice was instantiated from (using the information in the ‘Pointer to NST’ data field 737).

Step 1503 comprises the control node 215 receiving a first value of the first performance indicator from a first communication network. The received first value relates to the one or more subscribers in the first communication network or to the first network slice in the first communication network.

In step 1505, the control node 215 determine a reliability of the received first value using a performance indicator profile.

Then, in step 1507, the control node 215 performs an action with respect to the request received in step 1501 based on the determined reliability of the received first value.

The control node 215 may have, or have access to, respective performance indicator profiles for different subscribers, groups of subscribers, and/or network slices. For example, in some embodiments, step 1505 can comprise using respective performance indicator profiles for the specific subscribers identified in the request received in step 1501. In some embodiments, step 1505 can comprise using a performance indicator profile for the group of subscribers identified in the request received in step 1501. In some embodiments, step 1505 can comprise using a performance indicator profile for the specific network slice identified in the request received in step 1501.

As described further below, in some embodiments the performance indicator profile can comprise information indicating typical values, and/or typical ranges of values, of the first performance indicator, and optionally also for further (i.e. different) performance indicators. Thus, where the performance indicator profile is specific to a particular subscriber, group of subscribers or network slice, the performance indicator profile can indicate typical values, and/or typical ranges of values, of the first performance indicator for that particular subscriber, group of subscribers or network slice.

In some embodiments, the typical values and/or typical ranges of values for the first performance indicator are derived from measurements or observations of subscribers and/or network slices in multiple mobile communication networks. These multiple mobile communication networks may be operated by different network operators (MNOs).

In some embodiments, the method of FIG. 15 can further comprise the control node 215 receiving a respective (‘second’) value of the first performance indicator from a second communication network. The second value of the first performance indicator relates to the one or more subscribers or to the first network slice in the second communication network. In this case, step 1505 can further comprise determining a reliability of the second value received from the second communication network using the performance indicator profile. The action performed in step 1507 with respect to the received request can be determined according to the reliability determined for each of the received values of the first performance indicator.

In some embodiments, the action to perform in step 1507 comprises sending the received first value to the third party node 217 if the first value is determined to be reliable. In some embodiments, the action to perform in step 1507 can be one or more of (i) sending the received first value to the third party node 217 if the first value is determined to be reliable; (ii) sending the received first value to the third party node 217 with a confidence indicator representing the reliability of the received first value (regardless of whether the confidence indicator indicates that the first value is reliable or unreliable); (iii) not sending the received first value if it is determined to be unreliable; and (iv) sending a notification to the communication network that provided the first value if the first value is determined to be unreliable, with the notification indicating that the received first value is unreliable.

In some embodiments, when the control node 215 determines the reliability of performance indicator values and first detects that one or more reported values may not be accurate or reliable, the action the control node 215 performs in step 1507 may always be option (ii), i.e. where the control node 215 communicates the KPI(s) to the third party node 217 but includes a confidence indicator indicating that the KPI(s) may be misreported. In some cases, the MNO/mobile communication network that reported the KPI(s) may also be notified (i.e. according to action (iv)), for example via the SCEF/NEF nodes from which the reported KPI(s) were received. Then, after a period has passed in which KPI(s) from an MNO are still being misreported or are “suspicious” (e.g. a period where more than a threshold number of KPIs have been misreported), the KPIs to be reported to the third party node 217 in response to the request received in step 1501 are filtered to only include those KPIs determined in step 1505 to be reliable or sufficiently reliable (i.e. the control node 215 operates according to action (iii) above). In some cases, all KPIs from that MNO may be filtered out. In the case of filtering out unreliable KPI(s), the control node 215 may also notify the relevant MNO that the KPI(s) are not reliable (i.e. action (iv)). If an MNO for whom all KPIs are being filtered out due to too many unreliable KPIs starts to report reliable KPIs again (which can be determined based on one or both of some time having elapsed and/or a threshold number of “reliable” KPIs having been received by the control node 215), then the control node 215 can remove the filtering restriction for that MNO and KPIs can be forwarded to the third party node 217 again.

In some embodiments, the control node 215 can determine the performance indicator profile for the one or more subscribers and/or the first network slice. The performance indicator profile can be determined prior to receiving the request in step 1501. In some embodiments, the performance indicator profile can be determined based on previous values of the first performance indicator for the one or more subscribers or the first network slice. In alternative embodiments, the performance indicator profile can be determined by training a machine learning model, MLM, to output a reliability indicator for an input value of the first performance indicator. The MLM can be trained using the previous values of the first performance indicator for the one or more subscribers and/or the first network slice. In some embodiments, the MLM can be trained using reinforcement learning (RL) techniques.

As noted above, in some embodiments the performance indicator profile (referred to in this section as a KPI profile) can indicate typical values, and/or typical ranges of values of one or more specific performance indicators (KPIs). Thus the KPI profile can be an indicator of the usual values of a KPI produced for a subscriber/UE, a group of subscribers/UEs and NSIs. In the following, the KPIs listed relate to a UE or a group of UEs, but this is not a closed list. Exemplary KPIs can relate to, or can be:
mobility data (i.e. how long the UE stays attached in every cell of the mobile communication network and to which cells it handovers to);
traffic data (i.e. the volume and type of data a UE produces);
power data (i.e. the power class of a UE and power state);
network attach and detach data (i.e. when and for how long a UE stays attached to the network).

Such metrics/performance indicators can be obtained via the Operations Support System (OSS) of an MNO and are available to SCEF/NEF nodes, so the SCEF/NEF nodes can send these metrics to the control node 215, if requested to do so.

For a network slice, metrics/performance indicators can be considered that may include, but are not limited to:
load of the network slice (e.g. percentage of load versus total capacity over time);
availability of the network slice (e.g. uptime-states like suspended, powered off, and restarting will contribute negatively to this KPI);
deployment, teardown and update time for the network slice.

This type of information is supplied to SCEF/NEF nodes by a Network Data Analytics Function (NWDAF) in the mobile communication network and/or a Management and Orchestration (MANO) entity that manages the deployment of these network slices.

Regardless of the KPIs selected, the KPls have qualitative or quantitative values that can be numerically represented (e.g. using integers or decimals). Given a selected set of KPIs to which a performance indicator profile is to relate (noting that a profile can relate to a single KPI), in some embodiments one or multiple ranges can be defined for these KPIs that are considered normal, e.g. non-suspicious, behaviour. In some embodiments, a performance indicator profile is linked to a subscriber/UE, a group of subscribers/UEs or a network slice or NST (i.e. the template from which an NSI was instantiated from).

For example, consider a profile P for a mission-critical service network slice. The parameter KPIRange_{ID} is a record of the range of the KPI, where ID denotes an identifier of the KPI (e.g. “load”, “availability”, etc.). There are a few properties for the range of the KPI:
the range can be continuous or discrete, or a combination of both, for example a continuous range of 0.3-0.4 (denoting, e.g., a load of 30% to 40% of the capacity of a network slice), or a combination of continuous and discrete 5-10, 14-18 (denoting, e.g., the duration of a subscriber/UE or group of subscribers/UEs staying attached to the network—e.g. a duration ranging between 5 to 10 minutes, and 14 to 18 minutes is acceptable);
there can be more than one record per KPI, for example marked by one or more contextual pointers. For example, one of these contextual pointers can be time of day. For different times of day, different ranges of KPIs may be considered normal. Another pointer can be the date, for example on weekends and on special occasions such as holidays, there may be different ranges of KPIs that are considered normal. Other contextual pointers can be weather, temperature and humidity, geographical location, etc.

As an example, consider the following performance indicator profile P for a network slice as well as the definition of the ranges. The KPI IDs KPI₁, KPI₂, KPI₃, KPI₄, KPIs correspond to load, availability, setup, teardown and update KPIs respectively, as described above.

Thus, P={KPI₁, KPI₂, KPI₃, KPI₄, KPI₅}, where:
KPI₁={0.3, 0.4} (minimum and maximum load that is considered “normal”);
KPI₂={{99, good_weather}, {97, bad_weather}} (this KPI has a contextual pointer attached to it and multiple records—in this case if the weather is bad, the availability of a slice is a lower);
KPI₃={12}, KPI₄={23}, KPI₅={12} (these KPIs indicate the time in seconds required for certain actions on the NSI instantiated from the NST).

Thus, based on the above exemplary performance indicator profile, in step 1505 the value(s) of the KPI(s) received in step 1503 can be compared against the ranges in the profile P.

As noted above, in an alternative approach to the performance indicator profile comprising typical values or ranges of values, the performance indicator profile can be determined by training a MLM, and the trained MLM performs the role of the performance indicator profile. In these embodiments, step 1505 comprises inputting a received performance indicator value into the trained MLM, and the MLM outputs a reliability indicator for that input performance indicator value.

In some embodiments, the MLM can be a neural network that is trained to detect correct ranges of performance indicator values. In some embodiments, the MLM can be a neural network that is trained to detect correct ranges of performance indicator values for a specific third party node 217. The neural network can be trained using a reinforcement learning (RL) technique.

In the simplest form of RL, an agent engages in some decision that is encoded as an “action” towards an “environment”. The environment observes the action and, based on how successful the action was, it rewards the agent and communicates the new state the environment is in after the action took place. This process is known as an “episode” and is repeated as many times as possible for the agent to learn which actions bring the better future rewards. There are different techniques that can be used for the agent to learn about the best action for a given state. One suitable technique is known as Deep Q-learning. This technique involves a neural network that uses as input a state and classifies all possible permutations of actions based on their likelihood to produce a larger or smaller future reward. This training technique is particularly effective when the action space is large, as is the present case, for example where the number of different KPIs and ranges for those KPIs can vary greatly, so there are many permutations.

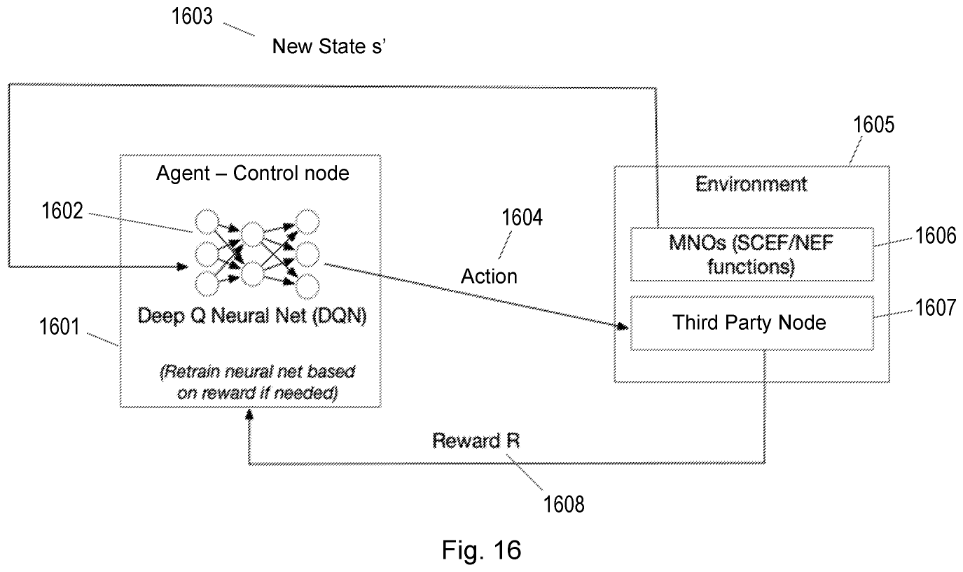

FIG. 16 illustrates a reinforcement learning loop for a neural network applied to KPIs/performance indicators. Thus, the control node 1601 operates as the Agent of the RL loop and implements the neural network 1602. One or more reported KPIs are the “State” 1603 that is/are input to the Agent 1601. The Action 1604 produced by the Agent 1601 is a probabilistic decision of the control node 1601 on whether the State 1603 (the reported KPI(s)) has been misreported or not. The probabilistic decision 1604 can be in the form of a confidence indicator (e.g. a percentage) representing whether the input KPI(s) 1603 have been misreported or reported correctly. The Environment 1605 that produces the KPIs 1603 in this example consists of both the mobile communication networks/MNOs 1606 and the third party node 1607. The State 1603 is one or more KPIs reported from the MNOs 1606, while the third party node 1607 is used to validate whether the reported KPI is suspicious or not, and generates a reward 1608 that is fed back to the Agent 1601. The reward can be the fraction of correctly validated KPIs by the Agent 1601 versus the total number of KPIs (the correctness here can be provided by the MNOs 1606). In certain embodiments, the fraction can have a bias towards one or more KPIs (e.g. in case it is more important for a particular KPI to be reported correctly than others). This bias can be mathematically expressed using weight coefficients. Depending on the reward 1608 provided to the neural network 1602, the neural network 1602 may need to be retrained to improve the accuracy of the confidence indicator (Action 1604).

Thus, in some embodiments there can be a ‘bootstrapping’ phase in which the third party node 1607 and one or more trusted MNOs 1606 participate, and from there on the neural network 1602 within the Agent 1601 is trained. The training process may be stopped when the Agent 1601 repeatedly receives high rewards 1608, indicating that it can validate if KPIs are reported correctly or not with sufficient accuracy (i.e. a level of accuracy sufficient for the third party node 1607. Thus, in some embodiments the third party node 1607 can provide the ‘ground truth’ for the training of the neural network 1602. In other embodiments, the ground truth can be provided by a different node. For example the manufacturer or owner of the control node 1601 may provide the rewards 1608 in order to train the neural network 1602, before the trained neural network 1602 is deployed for use by the third party node 1607.

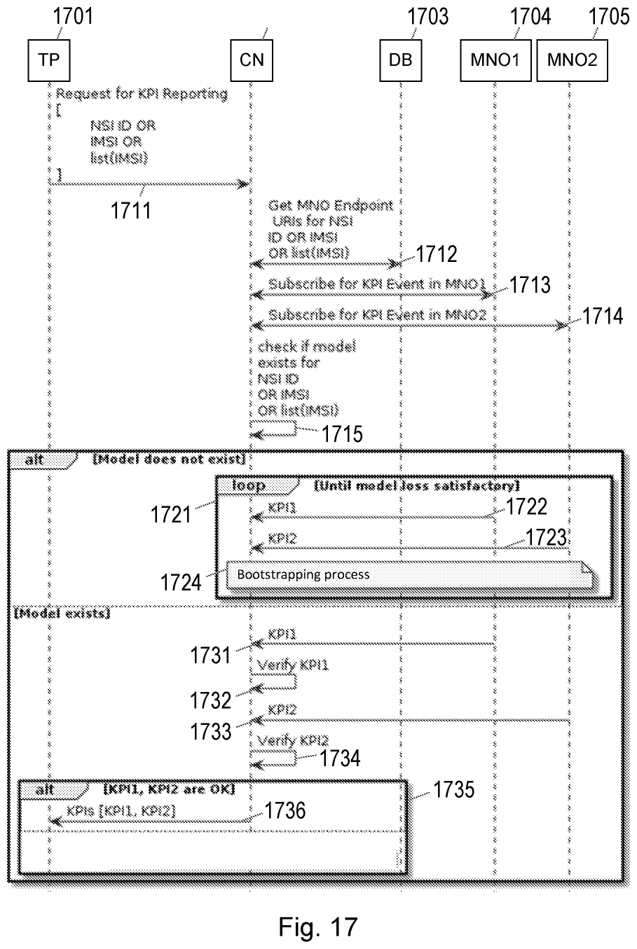

FIG. 17 is a signalling diagram illustrating the above exemplary process for determining the reliability of a reported KPI value. FIG. 17 illustrates various exemplary interactions between a third party node 1701, a control node 1702, a database 1703 in the form of a distributed ledger, and two MNOs/communication networks: MNO1 1704 and MNO2 1705.

Initially, the third party node 1701 sends a request 1711 for one or more KPIs to the control node 1702. The request 1711 indicates the subscriber(s) and/or network slices that the KPI(s) are to relate to. The receiving of the request 1711 by the control node 1702 corresponds to step 1501 above.

The control node 1702 interacts with the database 1703 to obtain the endpoint details for the MNOs relevant to the subscriber(s) and/or network slices indicated in the received request 1711. This interaction is represented by signal 1712, and results in the control node 1702 receiving the uniform resource indicators (URIs) for endpoints (e.g. a SCEF/NEF) in both of MNO1 1704 and MNO2 1705, as the relevant subscriber(s) are connected to one of those networks and/or those networks provide the relevant network slice.

Next, the control node 1702 sends a subscription request 1713 to MNO1 1704 requesting notification of a KPI Event (corresponding to the one or more KPIs indicated in the request 1711) when it occurs in MNO1 1704. The control node 1702 also sends a subscription request 1714 to MNO2 1705 requesting notification of a KPI Event (corresponding to the one or more KPIs indicated in the request 1711) when it occurs in MNO2 1705.

At step 1715, the control node 1702 determines or check if a performance indicator profile (e.g. a trained MLM) exists for the subscriber(s) and/or network slice indicated in the request 1711.

If not performance indicator profile exists, then in process 1721 the control node 1702 determines the performance indicator profile. In particular the control node 1702 can receive KPI values from MNO1 (e.g. KPI1 1722) and MNO2 (e.g. KPI2 1723), and follow the ‘bootstrapping’ process 1724 outlined above to determine the typical values/ranges of values or trained MLM.

Once the performance indicator profile is available, or if step 1715 determines that a performance indicator profile is available, when the control node 1702 receives a KPI from MNO1 1704 (e.g. KPI1 1731)—corresponding to step 1503 above—then at step 1732 the control node 1702 verifies the reliability of the KPI value using the performance indicator profile. Step 1732 corresponds to step 1505 above. Likewise, when the control node 1702 receives a KPI from MNO2 1705 (e.g. KPI2 1733)—corresponding to step 1503 above—then at step 1734 the control node 1702 verifies the reliability of the KPI value using the performance indicator profile. Step 1732 corresponds to step 1505 above.

If one or both of the received KPI values are considered reliable, then the control node 1702 can report these to the third party node 1701, as shown by signal 1736. If one or more of the received KPIs are determined to be unreliable, then the control node 1702 can determine the action to perform in respect of those KPIs as described above with reference to step 1507.

As described herein, an apparatus, device, virtual apparatus or virtual device can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

The following numbered statements set out various exemplary, non-limiting, examples of the some of the techniques described herein.

1. A method of operating a control node, the method comprising:
storing a first distributed ledger that comprises network slice information, wherein the network slice information comprises information on types of network slices provided by a first communication network that is operated by a first network operator and information on types of network slices provided by a second communication network that is operated by a second network operator;
receiving, from a third party node, a request for a first performance indicator, wherein the request identifies one or more types of network slices that the first performance indicator is to relate to; and
identifying the respective communication networks that provide the one or more types of network slices using the network slice information stored in the first distributed ledger.

2. A method as defined in statement 1, wherein the method further comprises:
requesting performance information relating to the first performance indicator for the one or more identified types of network slices in the respective identified communication networks.

3. A method as defined in statement 2, wherein the method further comprises:
determining the performance information to be requested based on the first performance indicator.

4. A method as defined in statement 2 or 3, wherein the step of requesting performance information comprises:
subscribing to an event relating to the first performance indicator for the one or more identified types of network slices in the respective identified communication networks.

5. A method as defined in statement 4, wherein the method further comprises:
querying the first distributed ledger to obtain further network slice information relating to the one or more types of network slices that the first performance indicator is to relate to; and
updating the subscription to the event for any type of network slice for which the network slice information has changed.

6. A method as defined in any of statements 2-5, wherein the method further comprises:
receiving the requested performance information from the respective identified communication networks.

7 A method as defined in statement 6, wherein the method further comprises:
determining the first performance indicator from the received performance information.

8. A method as defined in statement 7, wherein the method further comprises:
sending the determined first performance indicator to the third party node.

9. A method as defined in any of statements 1-8, wherein the step of identifying (1203) the respective communication networks for the one or more identified subscribers comprises receiving an address for an endpoint of the communication network that a respective identified subscriber is connected to.

10. A method as defined in any of statements 1-9, wherein the method further comprises:
receiving updated network slice information from one or both of the first network operator and the second network operator relating to network slices provided by the respective one of the first communication network and the second communication network; and
storing the updated network slice information in the first distributed ledger.

11. A method as defined in any of statements 1-10, wherein the first distributed ledger comprises:
a first list of network slice identifiers for types of network slices provided by the first communication network; and
a second list of network slice identifiers for types of network slices provided by the second communication network.

12. A method as defined in statement 11, wherein a respective timestamp is associated with the first list and the second list.

13. A method as defined in any of statements 11-12, wherein the first list is stored in the first distributed ledger as a respective block of a first blockchain for the first communication network, and the second list is stored in the first distributed ledger as a respective block of a second blockchain for the second communication network.

14. A method as defined in statement 13 when dependent on statement 10, wherein the updated network slice information comprises an updated first list and/or an updated second list; and
wherein the updated first list is stored in the first distributed ledger as a further block of the first blockchain, and the second updated list is stored in the first distributed ledger as a further block of the second blockchain.

15. A method as defined in any of statements 1-14, wherein the method further comprises:
receiving trust information from the third party node, wherein the trust information relates to a reliability of a value of the first performance indicator for one or both of the first communication network and the second communication network; and
storing the received trust information in the first distributed ledger or in a third distributed ledger.

16. A method as defined in statement 15, wherein the received trust information is stored as a block in a trust information blockchain in the first distributed ledger or in the third distributed ledger.

17. A method as defined in any of statements 1-16, wherein the communication network is a wireless communication network.

18. A method as defined in statement 17, wherein the first communication network has one of a Network Exposure Function, NEF, and a Service Capability Exposure Function, SCEF, and the second communication network has one of a NEF and a SCEF, and wherein the subscriber information for the subscribers connected to the first communication network is obtained via the one of the NEF and the SCEF of the first communication network, and the subscriber information for the subscribers connected to the second communication network is obtained via the one of the NEF and the SCEF of the second communication network.

19. A method of operating a network node in a first communication network that is operated by a first network operator, the method comprising:
storing (1301) a first distributed ledger that comprises network slice information, wherein the network slice information comprises information on types of network slices provided by the first communication network and information on types of network slices provided by a second communication network that is operated by a second network operator; and
storing (1302), in the first distributed ledger or in a second distributed ledger, trust information relating to a reliability of a value of a first performance indicator for one or both of the first communication network and the second communication network.

20. A method as defined in statement 19, wherein the method further comprises:
storing updated network slice information relating to types of network slices provided by the first communication network in the first distributed ledger.

21. A method as defined in any of statements 19-20, wherein the first distributed ledger comprises:
a first list of network slice identifiers for types of network slices provided by the first communication network; and
a second list of network slice identifiers for types of network slices provided by the second communication network.

22. A method as defined in statement 21, wherein a respective timestamp is associated with the first list and the second list.

23. A method as defined in any of statements 19-22, wherein the first list is stored in the first distributed ledger as a respective block of a first blockchain for the first communication network, and the second list is stored in the first distributed ledger as a respective block of a second blockchain for the second communication network.

24. A method as defined in statement 23 when dependent on statement 20, wherein the updated network slice information comprises an updated first list; and
wherein the updated first list is stored in the first distributed ledger as a further block of the first blockchain.

25. A computer program product comprising a computer readable medium having computer readable code embodied therein, the computer readable code being configured such that, on execution by a suitable computer or processor, the computer or processor is caused to perform the method of any of statements 1-24.

26. A control node, the control node configured to:
store a first distributed ledger that comprises network slice information, wherein the network slice information comprises information on types of network slices provided by a first communication network that is operated by a first network operator and information on types of network slices provided by a second communication network that is operated by a second network operator;
receive, from a third party node, a request for a first performance indicator, wherein the request identifies one or more types of network slices that the first performance indicator is to relate to; and
identify the respective communication networks that provide the one or more types of network slices using the network slice information stored in the first distributed ledger.

27. A network node for use in a first communication network that is operated by a first network operator, the network node configured to:
store a first distributed ledger that comprises network slice information, wherein the network slice information comprises information on types of network slices provided by the first communication network and information on types of network slices provided by a second communication network that is operated by a second network operator; and
store, in the first distributed ledger or in a second distributed ledger, trust information relating to a reliability of a value of a first performance indicator for one or both of the first communication network and the second communication network.

28. A control node, the control node comprises a processor and a memory, said memory containing instructions executable by said processor whereby said control node is operative to:
store a first distributed ledger that comprises network slice information, wherein the network slice information comprises information on types of network slices provided by a first communication network that is operated by a first network operator and information on types of network slices provided by a second communication network that is operated by a second network operator;
receive, from a third party node, a request for a first performance indicator, wherein the request identifies one or more types of network slices that the first performance indicator is to relate to; and
identify the respective communication networks that provide the one or more types of network slices using the network slice information stored in the first distributed ledger.

29. A network node for use in a first communication network that is operated by a first network operator, the network node comprises a processor and a memory, said memory containing instructions executable by said processor whereby said network node is operative to:
store a first distributed ledger that comprises network slice information, wherein the network slice information comprises information on types of network slices provided by the first communication network and information on types of network slices provided by a second communication network that is operated by a second network operator; and
store, in the first distributed ledger or in a second distributed ledger, trust information relating to a reliability of a value of a first performance indicator for one or both of the first communication network and the second communication network.

1. A method of operating a control node, the method comprising:
receiving, from a third party node, a request for a value of a first performance indicator relating to one or more subscribers or to a first network slice;
receiving, from a first communication network, a first value of the first performance indicator relating to the one or more subscribers in the first communication network or to the first network slice in the first communication network;
determining a reliability of the received first value using a performance indicator profile; and
performing an action with respect to the received request based on the determined reliability of the received first value.

2. The method as claimed in claim 1, wherein there is a respective performance indicator profile relating to each subscriber, to respective groups of subscribers, and/or to respective network slices.

3. The method as claimed in claim 1, wherein the step of determining the reliability uses one or more performance indicator profiles relating to the one or more subscribers or the first network slice indicated in the request.

4. The method as claimed in claim 1, wherein the performance indicator profile comprises information indicating typical values, or typical ranges of values, of the first performance indicator for the one or more subscribers or for the first network slice.

5. The method as claimed in claim 1, wherein the performance indicator profile further comprises information indicating typical values, or typical ranges of values, of one or more further performance indicators for the one or more subscribers or the first network slice.

6. The method as claimed in claim 1, wherein the method further comprises:
receiving, from a second communication network, a second value of the first performance indicator relating to the one or more subscribers in the second communication network or to the first network slice in the second communication network;
wherein the step of determining a reliability comprises determining a reliability of the second value received from the second communication network using the performance indicator profile; and
wherein the step of performing an action comprises performing a respective action with respect to the received request based on the determined reliabilities of the received values.

7. The method as claimed in claim 6, wherein the first communication network and the second communication network are operated by different communication network operators.

8. The method as claimed in claim 1, wherein the action to perform comprises sending the received first value of the first performance indicator to the third party node if the first value is determined to be reliable.

9. The method as claimed in claim 1, wherein the action to perform comprises one or more of:
(i) sending the received first value of the first performance indicator to the third party node with a confidence indicator representing the reliability of the received first value;
(ii) not sending the received first value of the first performance indicator if the received first value of the first performance indicator is determined to be unreliable;
(iii) sending a notification to the first communication network if the first value of the first performance indicator is determined to be unreliable, the notification indicating that the received first value is unreliable.

10. The method as claimed in claim 1, wherein the method further comprises:
determining the performance indicator profile for the one or more subscribers or the first network slice.

11. The method as claimed in claim 10, wherein the step of determining the performance indicator profile comprises determining the performance indicator profile based on previous values of the first performance indicator for the one or more subscribers or the first network slice.

12. The method as claimed in claim 11, wherein the step of determining the performance indicator profile comprises training a machine learning model, MLM, to output a reliability indicator for a value of the first performance indicator that is input to the trained MLM, wherein the MLM is trained using the previous values of the first performance indicator for the one or more subscribers or the first network slice.

13. The method as claimed in claim 12, wherein the MLM is trained using reinforcement learning techniques.

14. The method as claimed in claim 1, wherein the method further comprises:
storing a first distributed ledger that comprises network slice information, wherein the network slice information comprises information on types of network slices provided by a first communication network that is operated by a first network operator and information on types of network slices provided by a second communication network that is operated by a second network operator; and
after receiving the request for the value of the first performance indicator relating to a first network slice, identifying, using the network slice information stored in the first distributed ledger, the respective communication networks that provide the first network slice.

15. (canceled)

16. A control node comprising:
processing circuitry;
memory coupled with the processing circuitry, wherein the memory includes instructions that when executed by the processing circuitry causes the control node to perform operations comprising:
receive, from a third party node, a request for a value of a first performance indicator relating to one or more subscribers or to a first network slice;
receive, from a first communication network, a first value of the first performance indicator relating to the one or more subscribers in the first communication network or to the first network slice in the first communication network; and
determine a reliability of the received first value using a performance indicator profile; and perform an action with respect to the received request based on the determined reliability of the received first value.

17. The control node as claimed in claim 16, wherein there is a respective performance indicator profile relating to each subscriber, to respective groups of subscribers, and/or to respective network slices.

18. The control node as claimed in claim 16, wherein the control node is configured to determine the reliability using one or more performance indicator profiles relating to the one or more subscribers or the first network slice indicated in the request.

19. The control node as claimed in claim 16, wherein the performance indicator profile comprises information indicating typical values, or typical ranges of values, of the first performance indicator for the one or more subscribers or for the first network slice.

20. The control node as claimed in claim 16, wherein the performance indicator profile further comprises information indicating typical values, or typical ranges of values, of one or more further performance indicators for the one or more subscribers or the first network slice.

21. The control node as claimed in claim 16, wherein the control node is further configured to:
receive, from a second communication network, a second value of the first performance indicator relating to the one or more subscribers in the second communication network or to the first network slice in the second communication network;
wherein the control node is configured to determine the reliability of the second value received from the second communication network using the performance indicator profile; and
wherein the control node is configured to perform a respective action with respect to the received request based on the determined reliabilities of the received values.

22-43. (canceled)
